(19) United States
(12) Patent Application Publication
(10) Pub. No.: US 2026/0306217 A1
(43) Pub. Date: Oct. 8, 2026

(54) WEDGELESS SECTIONAL MATRIX SYSTEM FOR DENTAL RESTORATIONS

(71) Applicant: Jaemin Lee, Innisfil Beach (CA)

(72) Inventor: Jaemin Lee, Innisfil Beach (CA)

(21) Appl. No.: 19/571,035

(22) Filed: Mar. 18, 2026

Related U.S. Application Data
(63) Continuation-in-part of application No. 19/367,174, filed on Oct. 23, 2025.
(60) Provisional application No. 63/782,726, filed on Apr. 3, 2025.

(51) Int. Cl. A61C 5/85

(52) U.S. Cl. CPC A61C 5/85

(57) ABSTRACT

A dental implement for use in engaging a matrix band including at least one body with a distal side configured to be positioned against two adjacent teeth and a flexible blade extending from the distal side of the body. When the body is positioned against the two teeth, the blade is positioned between the teeth and is configured to be rotated such that the blade engages the matrix band to push the matrix band against one of the teeth.

### PRIORITY CLAIM/INCORPORATION BY REFERENCE

This application is a continuation-in-part of U.S. patent application Ser. No. 19/367,174, filed on Oct. 23, 2025 and titled “Wedgeless Sectional Matrix System For Dental Restorations,” which claims priority to U.S. Provisional Patent Application No. 63/782,726, titled “Wedge-less Sectional Matrix System” and filed Apr. 3, 2025. U.S. patent application Ser. No. 19/367,174 and U.S. Provisional Patent Application No. 63/782,726 are incorporated by reference in their entireties.

### FIELD OF THE TECHNOLOGY

Certain embodiments of the disclosure relate to a wedge-less sectional matrix system for use in dental restorations. More specifically, the system is a reusable dental separator that creates spaces between adjacent dentition and helps contour restorative material around the contact area of a tooth by causing a matrix band to follow the emergence profile of the tooth surface after placement of the separator.

### BACKGROUND

A dental separator and sectional matrix are used in dentistry to restore posterior proximal surface caries of a tooth. After the decayed area of the tooth has been removed, a restorative material is used to fill the gap in, and restore, the tooth. Resin composite is often used as a restorative filling material. Resin composite also goes through polymerization shrinkage after undergoing a curing process with a light, making it difficult to create proper contact surfaces for the treated tooth. Creating a tight contact area is important in order to prevent food impaction between the restored tooth surface and an adjacent tooth. A sectional matrix band with various sized wedges may be used to shape and contour the filling material against the natural tooth surface and hold the restorative material in place until it sets, creating a stable, smooth surface convexity around the contact area and anatomical cervical emergence without an overhang near the cervical margin of the restoration. A sectional matrix band is inserted between teeth by a dental separator.

Wedges are commonly used to stabilize the matrix band after it has been inserted. Wedges are placed either buccally and/or lingually against the matrix band and between the tooth to be treated (or prepped tooth) and an adjacent tooth. Sometimes multiple wedges are utilized at once in the same proximal space. Wedges help stabilize the matrix band so it forms a cervical seal gingival to the prepped margin. A wedge is also used to prevent an overhang. Ill-fitting wedges or inadequately placed ones can impinge on the matrix, resulting in distortion and creating a suboptimal emergence profile on restoration. Further, unlike circumferential matrices, sectional matrices are passively positioned and tend to move until the wedge(s) is/are securely positioned into place. Even then, subsequently applying forces from the dental separator buccolingually or the movement of patient's soft tissue can shift the matrix and open up gaps between the matrix and the prepped tooth. Also, multiple wedges (which are often made of plastic or wood) are often wasted in the course of trying to find the correct fit for the wedge in the space between teeth.

### SUMMARY

Certain aspects of the present technology provide a dental implement for inserting a matrix band. The implement includes an open ring with flexible legs and a body positioned on at least one of the legs and that is configured to releasably engage the matrix band. The implement includes a shaft that can move axially within the body. When the implement is inserted in a patient's mouth to position the matrix band along a first tooth, the shaft is configured to extend out of the body and between the first tooth and a second tooth adjacent the first tooth and move to apply pressure on the matrix band to press the matrix band against a portion of the first tooth.

In some embodiments, the implement may include a flexible blade that is configured to receive the shaft and extend between the first tooth and second tooth with the shaft. The shaft may be a hex key, and the hex key is received in a cylinder in the body, and the cylinder is shaped to correspond to the shape of the hex key such that rotation of the cylinder causes rotation of the hex key. The body may include a gear system that includes (i) a gear knob external of the body and that is connected to a first gear in the body and (ii) a second gear connected to the cylinder and that engages the first gear, wherein rotation of the gear knob causes the cylinder and the hex key to rotate. The gear system may include a ratchet wheel connected to an end of the leg and a gear connected to the cylinder that engages the ratchet wheel, wherein rotation of the ring causes the ratchet wheel to rotate in a first direction, which causes the gear and cylinder to rotate in a second direction. The gear system may further include a pawl that is configured to engage the ratchet wheel and a control lever, wherein the control lever can be moved to cause the pawl to engage and disengage the ratchet wheel. The blade may include an extension that is configured to be positioned in a pathway in the body and extend from an exit in the body and releasably engage the matrix band. The blade may include first and second blade portions connected by a flexible arch and a body is positioned on both legs and wherein the shaft of one of the bodies is connected to the first blade portion and the shaft of the other body is connected to the second blade portion. The blade may include first and second blade portions connected by a flexible arch, wherein the body is configured to receive first and second shafts, the first shaft being connected to the first blade portion and the second shaft being connected to the second blade portion. The body may include a gear system that is configured to rotate the first shaft a first direction and rotate the second shaft a second direction opposite the first direction.

Certain aspects of the present technology provide a dental implement for inserting a matrix band. The implement includes an open ring body with flexible legs that define a gap therebetween and a body positioned on at least one of the legs and that is configured to engage one of the flexible legs. The implement includes a flexible blade configured to releasably connect to the body and to retain a matrix band. When the implement is inserted in a patient's mouth to position the matrix band along a first tooth, the blade is configured to extend between the first tooth and a second tooth adjacent the first tooth and move to press a portion of the matrix band against a portion of the first tooth.

In some embodiments the implement may further include a hex key that is received in a cylinder in the body and the cylinder is shaped to correspond to the shape of the hex key such that rotation of the cylinder causes rotation of the hex key. The implement may include a gear system including (i) a gear knob external of the body and that is connected to a first gear in the body and (ii) a second gear connected to the cylinder and that engages the first gear, wherein rotation of the gear knob causes the cylinder and the hex key to rotate. The blade may include an extension that is configured to be positioned in a pathway in the body and extend from an exit in the body and releasably engage the matrix band. The gear system may include a ratchet wheel connected to an end of the leg and a gear connected to the cylinder that engages the ratchet wheel, wherein rotation of the ring causes the ratchet wheel to rotate in a first direction, which causes the gear and cylinder to rotate in a second direction. The blade may include first and second blade portions connected by a flexible arch and the two blade portions and a body are positioned on both legs and wherein the shaft of one of the bodies is connected to the first blade portion and the shaft of the other body is connected to the second blade portion. The blade may include a head configured to releasably engage a notch of the body, wherein when the body is released from the open ring body, the head disengages from the notch.

Certain aspects of the present technology provide a dental implement including an open ring with flexible legs that define a gap therebetween, a body positioned on an end of each leg, wherein each body includes a gear system and a hex key that can move within the body, and a flexible blade mounted to each hex key that is configured to retain the matrix band. The legs are configured (i) to move away from each other in order to position the matrix band on a first tooth and (ii) to move toward each other such that each body engages the first tooth and a second tooth adjacent the first tooth and the blades disengage from the matrix band. The shafts are configured to (i) be moved axially toward each other between the first tooth and the second tooth such that the blades press against the matrix band, and (ii) be rotated via the gear system such that the blades rotate and press against the matrix band proximate the gingival margin.

In some embodiments, the hex key is received in a cylinder in the body and the cylinder is shaped to correspond to the shape of the hex key such that rotation of the cylinder by the gear system causes rotation of the hex key.

Certain aspects of the present technology provide a method for securing a matrix band to a tooth including the steps of providing an open ring with flexible legs and a body positioned on at least one leg, connecting a flexible blade to the body, releasably connecting a matrix band to the flexible blade, positioning the matrix band along a first tooth, and flexing the legs to release the matrix band and cause the blade to secure the matrix in place against a prepared surface of the tooth. In some embodiments, the body may include a gear or lever that operates to cause the blade to push against the matrix and in a further embodiment the body may include a shaft that operates to engage the blade to move it against the matrix.

Certain aspects of the present technology provide a dental implement for use in engaging a matrix band that includes at least one body with a distal side configured to be positioned against two adjacent teeth and a flexible blade extending from the distal side of the body. When the body is positioned against the two teeth, the blade is positioned between the teeth and is configured to be rotated such that the blade engages the matrix band to push the matrix band against one of the teeth.

In some embodiments, the body may include a gear that is configured to rotate the blade. The body may receive a shaft on a proximal side thereof, and the shaft may engage the gear and blade such that the gear causes the blade to rotate by rotating the shaft. The blade may be configured to push the teeth apart to increase interproximal space therebetween. The shaft may be configured to move axially within the body and between the two teeth. The implement may include a flexible member and a spring, and the spring includes at least one extension that extends through a pathway in the body and is configured to be connected to the matrix band. The shaft may extend out a distal side of the body and through the flexible member and the spring may and may be configured to be lockingly engaged to the blade. The body may engage the blade to retain the flexible member and the spring in a chamber in the body with the flexible member in a contracted state. The implement may include a pad positioned in the body, and at least one of the pad and body define the chamber. The implement may include an open ring with two flexible legs and two bodies, wherein each leg includes a body connected at an end thereof. When the ring is positioned in a patient's mouth to position the matrix band between the teeth, the legs may be released from an expanded position to a contracted position, and the contraction may cause the pad on each body to deform and disengage the blade from the body such that the flexible member expands and causes the shaft to move axially out of the distal side of the body and between the two teeth and causes the extension to disengage from the matrix band and retract into the body. The blade may include an extension that retainably engages a notch of the tine body. The flexible member may be a ring spring, wave spring, coil spring, or prolate shaped elastomer, and the spring may be a leaf spring. The shaft may be a hex key. The gear may include a knob connected by gears to a cylinder in the body that receives the shaft such that rotation of the knob causes the shaft to rotate. The shaft may include a ball or stop at one end to prevent the shaft from moving into the body beyond a certain point. The body may include a button that is configured to be depressed to cause the blade to disengage from the body such that the flexible member expands and causes the shaft to move axially out of the body and between the two teeth and causes the extension to disengage from the matrix band.

Certain aspects of the present technology provide a dental implement for inserting a matrix band that includes an open ring with flexible legs, a body positioned on at least one of the legs and that is configured to releasably engage the matrix band, a shaft configured to be received within the body, a flexible blade that is configured to be connected to the shaft, and a gear configured to rotate the shaft. When the implement is inserted in a patient's mouth to position the matrix band along a first tooth, the shaft and blade are configured to move axially between the first tooth and a second tooth adjacent the first tooth and be rotated by the gear system to apply pressure on the matrix band to press the matrix band against a portion of the first tooth.

In some embodiments, the implement may include a flexible member and a spring with at least one extension configured to be connected to the matrix band, the shaft may extend through the flexible member and the spring and be configured to be lockingly engaged to the blade, and the body may retainably engage the blade to retain the flexible member and the spring in a contracted state. The implement may include a pad positioned on the body, and when the ring separator is positioned in the patient's mouth to position the matrix band between teeth, the legs may be released from an expanded position to a contracted position, the contraction causing the pad to deform and disengage the blade from the tine body, which allows the flexible member to expand and (i) drive the shaft axially out of the body and between the first tooth and the second tooth, and (ii) pull the extension such that it disengages from the matrix band. The body may include a button that is configured to be depressed to cause the blade to disengage from the tine body.

### BRIEF DESCRIPTION OF THE DRAWINGS

FIG. 1 illustrates a top isometric view of a ring separator device according to an embodiment of the present technology.

FIG. 2 illustrates a top isometric view of the ring separator device of FIG. 1 with a tine body removed.

FIG. 3 illustrates a top isometric view of the ring separator device of FIG. 1 in an expanded position.

FIG. 4 illustrates a top isometric view of the ring separator device of FIG. 1 with a matrix band mounted thereto.

FIG. 5 illustrates a top isometric view of the ring separator device of FIG. 1 positioned with the matrix band inserted along a tooth needing restoration.

FIG. 6a illustrates an isometric view of a matrix band according to an embodiment of the present technology.

FIG. 6b illustrates an isometric view of a doubled sided matrix band according to an embodiment of the present technology.

FIG. 7 illustrates a side view of the ring separator device of FIG. 5.

FIG. 8 illustrates a front isometric view of a tine body pad according to an embodiment of the present technology.

FIG. 9 illustrates a front isometric exploded view of a portion of a tine body and a pad according to an embodiment of the present technology.

FIG. 10a illustrates a cutaway side view of a tine body according to an embodiment of the present technology.

FIG. 10b illustrates a second cutaway side view of the tine body of FIG. 10a.

FIG. 10c illustrates a third cutaway side view of the tine body of FIG. 10a.

FIG. 10d illustrates a cutaway front view of the tine body of FIG. 10a.

FIG. 10e illustrates a second cutaway front view of the tine body of FIG. 10a.

FIG. 10f illustrates a third cutaway front view of the tine body of FIG. 10a.

FIG. 10g illustrates a fourth cutaway front view of the tine body of FIG. 10a.

FIG. 10h illustrates a cutaway top view of the tine body of FIG. 10a.

FIG. 10i illustrates a second cutaway top view of the tine body of FIG. 10a.

FIG. 10j illustrates a third cutaway top view of the tine body of FIG. 10a.

FIG. 10k illustrates a cutaway side view of a tine body according to another embodiment of the present technology.

FIG. 11a illustrates a top isometric view of a blade and hex key according to an embodiment of the present technology.

FIG. 11b illustrates a top isometric view of the blade and hex key of FIG. 11a separated.

FIG. 11c illustrates a top isometric view of a double blade according to an embodiment of the present technology.

FIG. 11d a top isometric view of the double blade of FIG. 11c being compressed.

FIG. 11e illustrates a top isometric view of a double blade according to an embodiment of the present technology.

FIG. 11f illustrates another top isometric view of the double blade of FIG. 11e.

FIG. 11g a top isometric view of the double blade of FIG. 11e being compressed.

FIG. 11h is a side view of the blade of FIG. 11a.

FIG. 12a illustrates a cross-sectional side view of a hex key and a blade positioned between two teeth according to an embodiment of the present technology.

FIG. 12b illustrates a cross-sectional side view of the hex key and a blade of FIG. 12a rotated to a different position.

FIG. 13a illustrates a top view of two hex keys and blades inserted between adjacent teeth according to an embodiment of the present technology.

FIG. 13b illustrates a top view of the hex keys and blades of FIG. 13a wherein the blades have been compressed to fill gaps between the teeth.

FIG. 14a illustrates a side isometric view of a ring separator device positioned with the matrix band inserted along a tooth needing restoration according to an embodiment of the present technology.

FIG. 14b illustrates a top view of the device of FIG. 14a.

FIG. 14c illustrates a top isometric exploded view of a ring separator device according to an embodiment of the present technology.

FIG. 15a illustrates a side isometric view of the device of FIG. 14a in operation.

FIG. 15b illustrates a side isometric view of the device of FIG. 14a in operation.

FIG. 16 illustrates a top view of a tine body of the embodiment shown in FIGS. 14a-14c.

FIG. 17 illustrates a side cutaway view of a tine body of the embodiment shown in FIGS. 14a-14c.

FIG. 18 illustrates a side cutaway view of a tine body according to an embodiment of the present technology.

FIG. 19a illustrates a side cutaway view of a tine body according to an embodiment of the present technology.

FIG. 19b illustrates a second cutaway side view of the tine body of FIG. 19a.

FIG. 19c illustrates a third cutaway side view of the tine body of FIG. 19a.

FIG. 19d illustrates a top cutaway view of the tine body of FIG. 19a.

FIG. 19e illustrates a second top cutaway view of the tine body of FIG. 19a.

FIG. 19f illustrates a third top cutaway view of the tine body of FIG. 19a.

FIG. 20a illustrates a top isometric view of the two hex keys and a double blade according to an embodiment of the present technology.

FIG. 20b illustrates a top isometric view of the hex keys inserted in the double blade of FIG. 20a.

FIG. 20c illustrates a top isometric view of the hex keys inserted in the double blade in an expanded position of FIG. 20a.

FIG. 20d illustrates a cross-sectional view of the double blade of FIG. 20a.

FIG. 20e illustrates a cross-sectional view of the expanded double blade of FIG. 20a.

FIG. 20f illustrates a cross-sectional side view of the hex keys and double blade of FIG. 20a inserted between adjacent teeth.

FIG. 20g illustrates a cross-sectional side view of the hex keys and double blade of FIG. 20a inserted between adjacent teeth with the blades pressing against matrix bands.

FIG. 21a illustrates a top isometric view of a hex blade holder according to an embodiment of the present technology.

FIG. 21b illustrates a close-up view of a portion of the holder of FIG. 21a.

FIG. 22a illustrates a top isometric view of pliers according to an embodiment of the present technology.

FIG. 22b illustrates a close-up view of a portion of the holder of FIG. 22a.

FIG. 23 illustrates a cutaway front view of a tine body and a flexible blade according to an embodiment of the present technology.

FIG. 24 illustrates an isometric view of the blade of FIG. 23.

FIG. 25 illustrates an isometric view of a head of the blade of FIG. 23 and a notch of the body of FIG. 23.

FIG. 26a illustrates a front view of the blade 300 of FIG. 23 being positioned between teeth above the gum line by the tine bodies of FIG. 23.

FIG. 26b illustrates a front view of the blade 300 of FIG. 23 being further positioned between teeth above the gum line by the tine bodies of FIG. 23.

FIG. 26c illustrates a front view of the blade 300 of FIG. 23 being released by the tine bodies of FIG. 23.

FIG. 27 illustrates a top isometric view of the ring separator device positioned with the matrix band inserted along a tooth needing restoration according to an embodiment of the present technology.

FIG. 28 illustrates a side isometric view of the ring separator device of FIG. 27.

FIG. 29 illustrates an exploded top view of the ring separator device of FIG. 27.

FIG. 30 illustrates a top isometric view of the ring separator device of FIG. 27 in a resting state.

FIG. 31 illustrates a top isometric view of the ring separator device of FIG. 27 in a flexed state.

FIG. 32 illustrates a top isometric view of a matrix band used with the ring separator of FIG. 27.

FIG. 33a illustrates an exploded isometric view of a hex key, ring spring, leaf spring, and blade according to an embodiment of the present technology.

FIG. 33b illustrates an isometric view of a coil spring.

FIG. 33c illustrates an isometric view of a prolate elastomer.

FIG. 33d illustrates a bottom cross-sectional view of a hex key being inserted into a blade and leaf spring according to an embodiment of the present technology.

FIG. 33e illustrates a bottom cross-sectional view of the hex key of FIG. 33d being snapably connected to the blade of FIG. 33d according to an embodiment of the present technology.

FIG. 33f illustrates a side view of flap of the hex key of FIG. 33d.

FIG. 33g illustrates a side isometric view of a compartment of a blade according to an embodiment of the present technology.

FIG. 34 illustrates a proximal cutaway side view of the blade of FIG. 33a.

FIG. 35 illustrates a distal cutaway side view of the blade of FIG. 33a.

FIG. 36a illustrates a top isometric view of the ring spring and leaf spring of FIG. 33a in locking position.

FIG. 36b illustrates top isometric view of a coil spring and a leaf spring in a locking position according to an embodiment of the present technology.

FIG. 36c illustrates top isometric view of a prolate elastomer component and a leaf spring in a locking position according to an embodiment of the present technology

FIG. 37a illustrates a top view of a tine body and arm of the ring separator of FIG. 27.

FIG. 37b illustrates a cutaway top view of the tine body and arm of FIG. 37a.

FIG. 37c illustrates a cutaway top view of a tine body and arm according to an embodiment of the present technology.

FIG. 38a illustrates a cutaway side view of the tine body of FIG. 27.

FIG. 38b illustrates a cutaway side view of the tine body of FIG. 27.

FIG. 38c illustrates a cutaway side view of the tine body of FIG. 27.

FIG. 39a illustrates a cutaway front view of the tine body of FIG. 27.

FIG. 39b illustrates a cutaway front view of the tine body of FIG. 27.

FIG. 39c illustrates a cutaway front view of the tine body of FIG. 27.

FIG. 39d illustrates a cutaway front view of a portion the tine body of FIG. 27 and a blade, leaf spring, ring spring, and hex key in a locked position according to an embodiment of the present technology.

FIG. 40 illustrates a top isometric cutaway view of a portion of the tine body of FIG. 27.

FIG. 41 illustrates a top isometric view of a blade, ring spring, leaf spring, and hex key in a non-compressed state according to an embodiment of the present technology.

FIG. 42 illustrates a top isometric view of a blade, ring spring, leaf spring, and hex key in a compressed state according to an embodiment of the present technology.

FIG. 43 illustrates a top cutaway view of a portion of the tine body of FIG. 27 and the hex key, ring spring, leaf spring, and blade of FIG. 33a in a locked position according to an embodiment of the present technology.

FIG. 44 illustrates a top cutaway view of a portion of the tine body of FIG. 27 and the hex key, ring spring, leaf spring, and blade of FIG. 33a in an unlocked position according to an embodiment of the present technology.

FIG. 45 illustrates a cutaway front view of a portion of the tine body of FIG. 27 and the hex key, blade, ring spring, and leaf spring of FIG. 33a in an unlocked position according to an embodiment of the present technology.

FIG. 46 illustrates a cutaway side view of a hex key and a blade positioned between two teeth and proximate a matrix band according to an embodiment of the present technology.

FIG. 47 illustrates a cutaway side view of the hex key and a blade of FIG. 46 rotated counterclockwise against the matrix band according to an embodiment of the present technology.

FIG. 48 illustrates a front isometric view of a pad according to an embodiment of the present technology.

FIG. 49 illustrates a rear isometric view of the pad of FIG. 48 with a portion of the pad positioned on a portion of an extension of the tine body according to an embodiment of the present technology.

FIG. 50 illustrates an isometric view of a matrix band according to an embodiment of the present technology.

FIG. 51 illustrates a cutaway side view of a blade positioned between two teeth and proximate the matrix band of FIG. 50 according to an embodiment of the present technology.

FIG. 52 illustrates a cutaway side view of the blade of FIG. 51 rotated counterclockwise against the matrix band of FIG. 50 according to an embodiment of the present technology.

The foregoing summary, as well as the following detailed description of certain embodiments of the present technology, will be better understood when read in conjunction with the appended drawings. For the purpose of illustrating the technology, there is shown in the drawings, certain embodiments. It should be understood, however, that the present technology is not limited to the arrangements and instrumentality shown in the attached drawings.

### DETAILED DESCRIPTION

Embodiments of the present technology include a dental implement in the form of a ring separator device with a pair of depending and converging tines that apply pressure buccolingually on an interproximal area between teeth to increase space between two adjacent teeth and to secure a matrix band to at least one of the teeth such that the tooth can be restored.

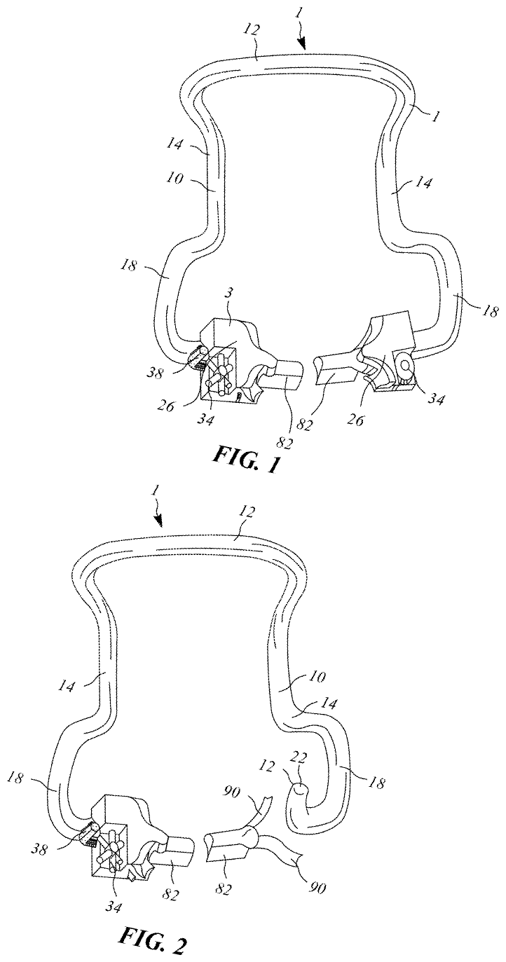

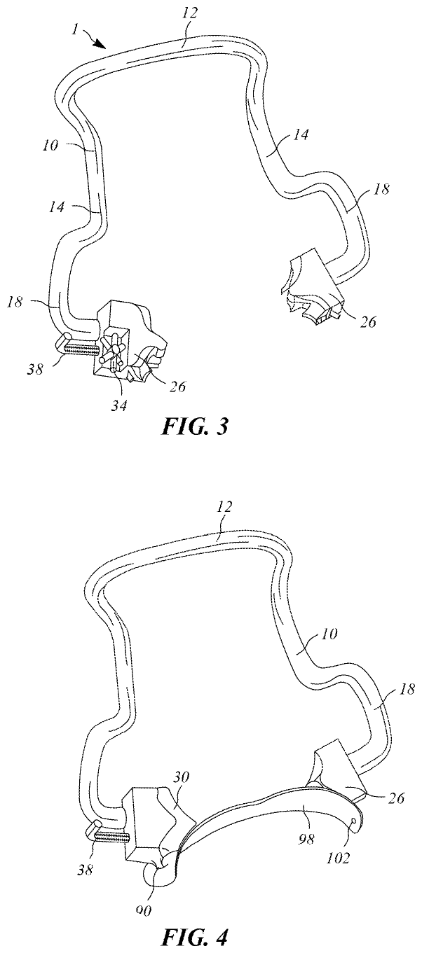

With respect to FIGS. 1-5 and 7, a ring separator device 1 includes a body 10 having an open ring shape. The body 10 includes a pair of legs 14 that extend downward and then forward from a central portion or handle 12 and define C-shaped notches 18 that end with tines 22 at distal ends of the legs 14 that extend generally upward. With reference to FIG. 3, the legs 14 have a spring tension and can be pulled apart from each other and pushed toward each other. By way of example only, the body 10 may be made of a metal or an alloy or other material that provides it with spring characteristics.

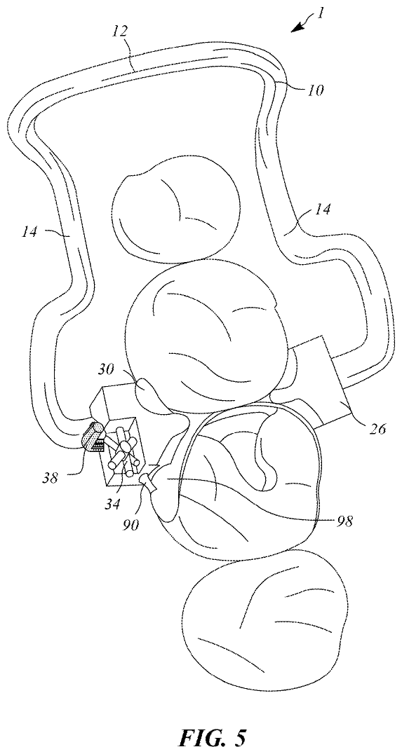

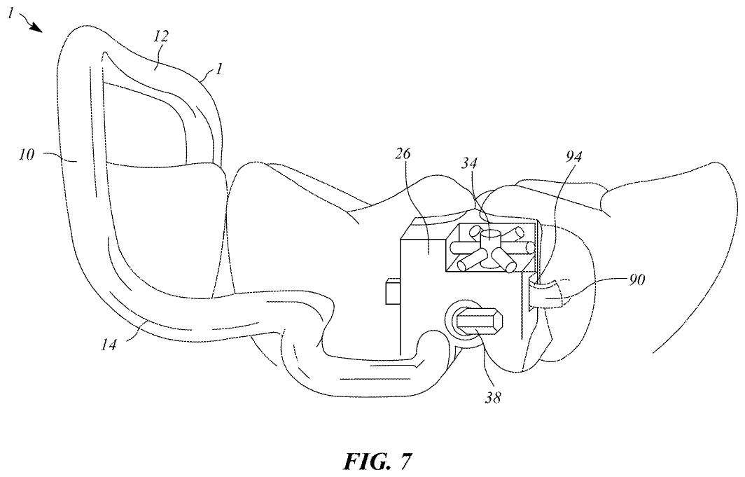

A secondary tine body 26 is formed over each underlying tine 22. Inside each tine body 26, the tine 22 extends in a generally upward direction from an end of the C-shaped notch 18, and the distal ends of the tines 22 are tilted slightly toward each other, which allows for the creation of inward and downward forces by the tine bodies 26 against dentition buccolingually. As shown in FIG. 5, the tine bodies 26 are configured to engage two adjacent teeth, and, with reference to FIGS. 5 and 7, each tine body 26 includes a pad 30 that follows the contour of the teeth for better adaptation. The pad 30 surface may be made of a medical grade silicone, rubber, or other elastomeric material to provide a non-slip surface for better adaptation to the teeth surfaces and to prevent slippage of the ring device 1 from the teeth surfaces. The rest of the tine body 26 may be made of a heat-resistant polymer or stainless steel, or similar metal alloy to provide a compartment in the tine body 26 for a gear system.

Each tine body 26 can include a gear system, although in some embodiments only one tine body 26 may include a gear system (or no gear at all). With respect to FIGS. 1-5 and 7, the gear systems include an external gear knob 34 and a shaft or rod 38. By way of example only, the shaft or rod 38 is an L-shaped hex key. Alternatively, the shaft or rod 38 can have different shapes. For example, it may have something besides six sides and/or can have different shapes than an L-shape.

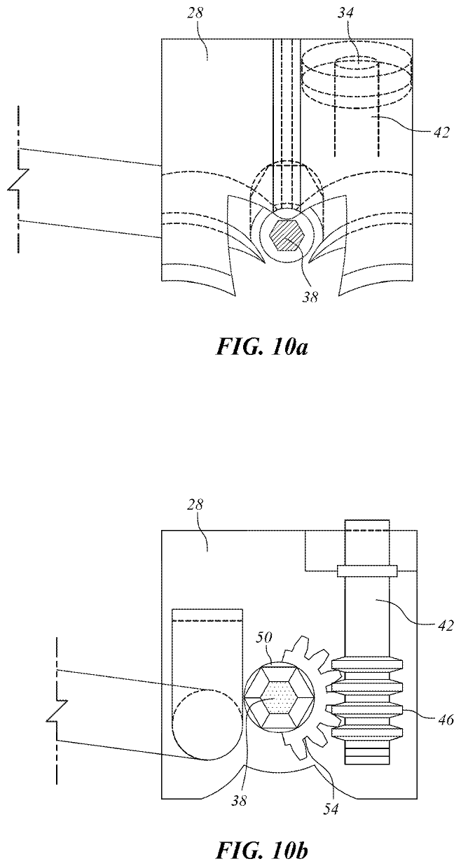

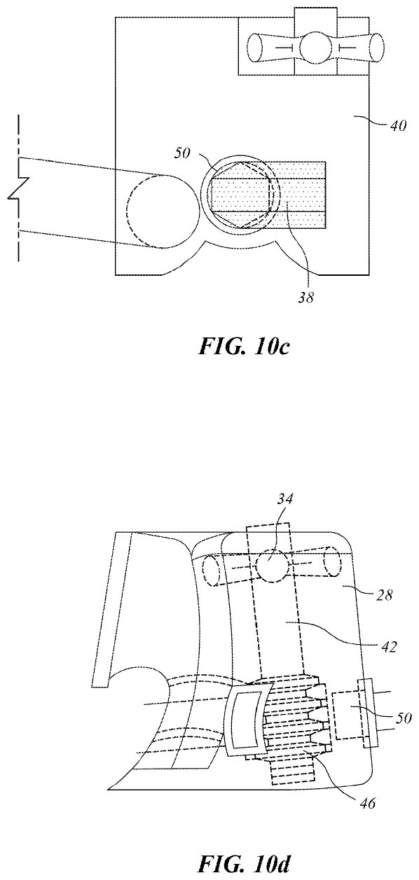

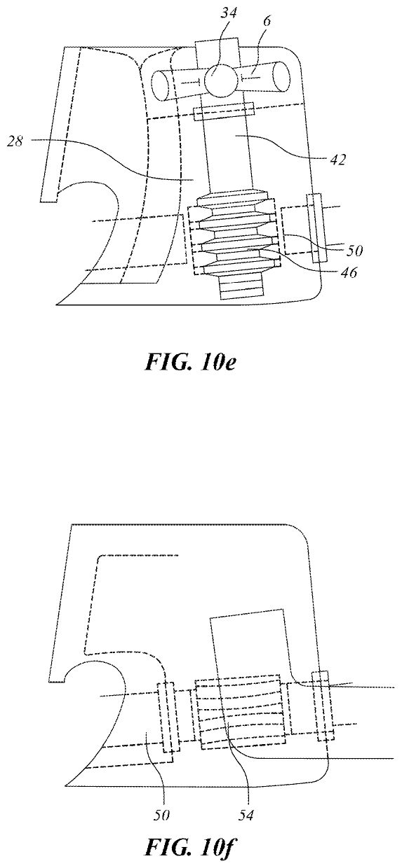

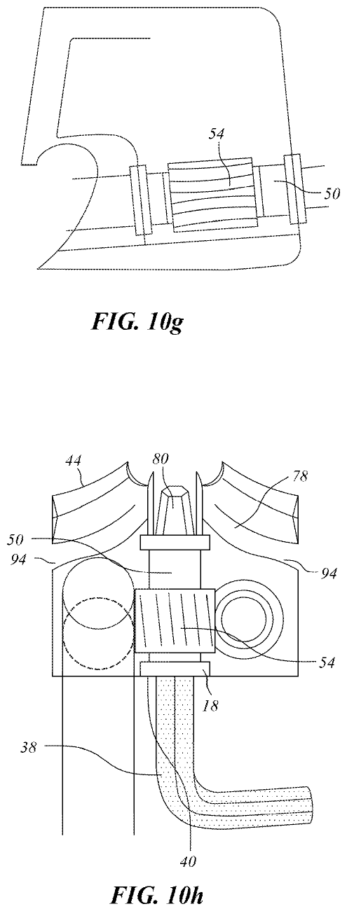

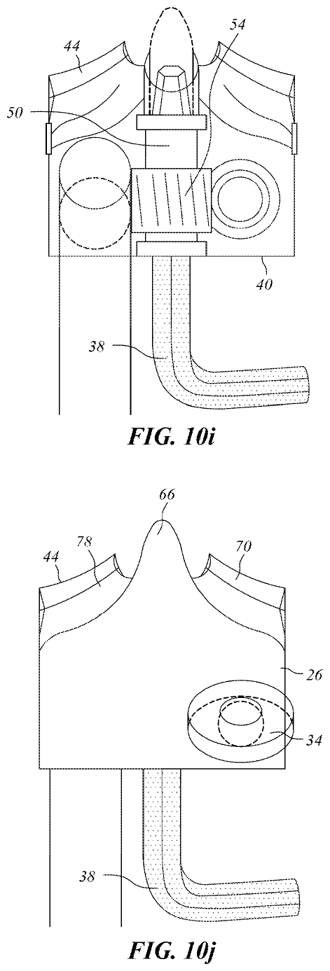

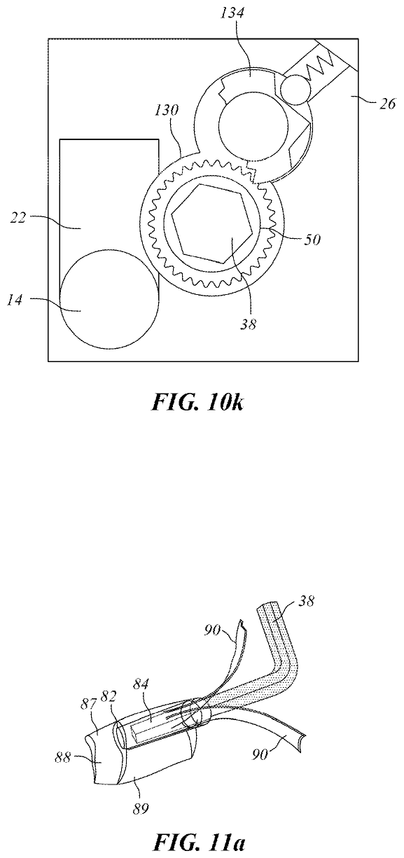

With respect to FIGS. 10a-10j, the external gear knob 34 is connected to a generally vertical shaft 42 inside a compartment 28 in the tine body 26, and the vertical shaft 42 includes a worm 46. The hex key 38 is received inside a generally horizontal cylinder 50 passing through the tine body compartment 28, either in a linguo-buccal direction or a buccolingual direction, and the horizontal cylinder 50 includes a worm wheel 54 that is configured to engage the worm 46. The hex key 38 is inserted into the cylinder 50 from a proximal side 40 of the tine body to a distal side 44 of the tine body 26. The inner surface of the horizontal cylinder 50 has a hexagonal cross-section, which corresponds to and accommodates the L-shaped hex key 38 such that the hex key 38 rotates with the horizontal cylinder 50, i.e., rotation of the cylinder 50 causes rotation of the hex key 38. In operation, due to the interconnection and engagement of the worm and worm wheel 46 and 54, when the external gear knob 34 of a tine body 26 is rotated, the hex key 38 of that tine body 26 rotates. The ends of the cylinder 50 and the shaft 42 may be retained in the tine body compartment 28 by bushings to reduce resistance against the compartment 28 walls when rotating. Alternatively or additionally, the compartment 28 may be made out of a polymer to reduce friction between the rotating shaft 42 and cylinder 50 and the compartment walls 28.

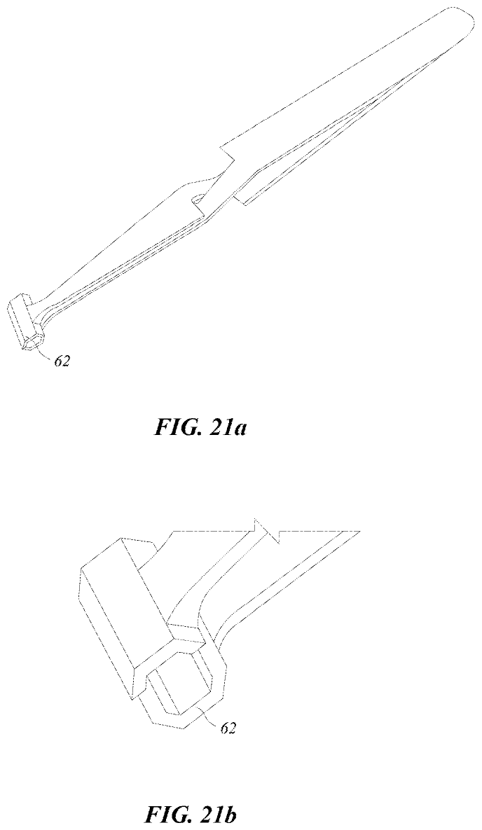

In some embodiments, the shaft 42, along with the worm 46 and the knob 34 can be slightly tilted. They can also be generally perpendicular to the worm wheel 54 attached to the cylinder 50. In some embodiments, only part of the worm wheel 54 contains teeth in order to save space inside the tine body compartment 28. The worm gear components 46 and 54, cylinder 50, hex key 38, shaft 42, and knob 34 may be made of a polymer, metal, or an alloy thereof. The hex key 38 may be replaceable and may have the least yield strength out of all the tine body 26 components in order to reduce the risk of gear failure when excessive force is applied through the knob 34. The gear knob 34 may have different sizes and shapes depending on space availability but is large enough for a user to engage it to control rotation of the vertical shaft 42 and thus the hex key 38. In some embodiments, the user can rotate the gear knob(s) 34 with their fingers. In addition, or alternatively, and with respect to FIGS. 21a and 21b, a hex blade holder (or pliers) with a lug nut key 62 can be used to rotate the gear knob 34.

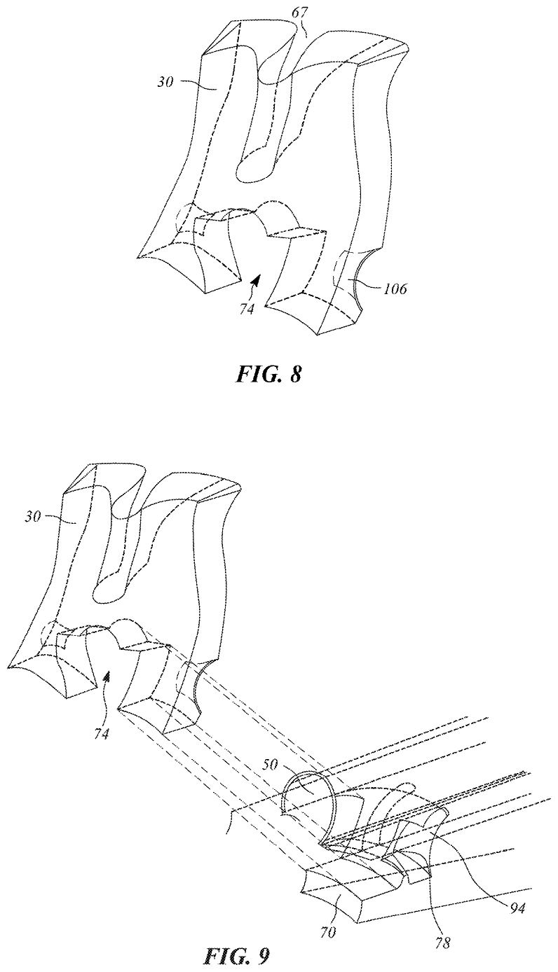

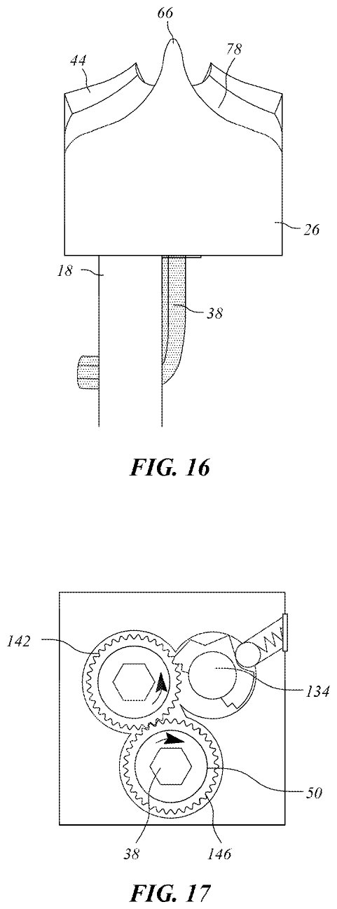

With respect to FIGS. 8, 9, 10j, and 16, the distal surface 44 of the tine body 26 is partially covered by the pad 30. A small extension 66 from the tine body 26 is received in a slot 67 in the pad 30 and provides extra support for, and maintains the integrity of, the pad 30 when the pad 30 is placed on the proximal surfaces of adjacent teeth. The tine body 26 includes a base with a bevelled extension 70 that follows the contour of the positive emergence profile of the gingival third of a tooth crown, preventing the matrix band (discussed below) and the sectional matrix ring from popping out of the intended site. As shown in FIG. 9, which shows a right side portion of the distal end 44 of the tine body 26 and how the pad 30 is positioned against the distal end 44 of the tine body 26, the pad 30 sits on and above the bevelled extension 70, which may be made of a hard acrylic, is not covered by the pad, and is facing the positive emergence profile of the tooth surface so that the ring does not pop or slide out once inserted (as discussed in more detail below). Also, the center part of the gingival third of tine body 26 is not covered by the pad 30, i.e., the pad 30 includes a gap 74, which provides the hex key 38 and a blade (discussed below) access to the cylinder 50 in the compartment 28 and to a blade extension pathway 78 in the tine body 26.

With respect to FIGS. 1-2 and 11a-11b and 11h, the hex key 38 has a tapered end 80 that extends inward from the tine body 26 and is configured to fit into a loading edge 86 of a reusable blade 82. The hex key 38 can be secured to the blade 82 by a spring snap like a lock and key mechanism or other known ways to snapably engage two components. The blade 82 has a leading edge 87 and a trailing edge 89. The loading edge 86 of the blade 82 is preferably made of a polymer that provides a firm yet bendable movement. The tip 88 of the blade and the trailing edge 89 may be made of soft elastomeric material to prevent trauma to soft gingival tissue. Also, the trailing edge 89 of the blade 82 may be made of a softer elastomeric material for better adaption to follow the emergence profile of tooth surface. A tapered end 80 of the hex key 38 fits into the harder elastomeric core of the blade 82. The inner portion of loading edge 86 includes a tube 84 that receives the tapered end 80 of hex key 38. The tube 84 extends to become a spring snap lock that diverges into two parts that become extensions 90. As discussed below, one of the extensions 90 provides support to the one side of the sectional matrix 98, and one of the other extensions from the opposing tine supports the other side of the sectional matrix 98.

With respect to FIGS. 7, 9, 10h, and 11a, the blade 82 is connected to a tine body 26 by positioning the blade extensions 90 in the pathway 78 of the tine body 26 with the ends of the extensions 90 extending out of exits 94 on opposite sides of the tine body 26. The tapered and progressively flattened end 80 of the hex key 38 is inserted from the proximal side 40 of the tine body 26, passes through the cylinder 50, and extends to the distal side 44 of the tine body 26 and snap fits into the loading edge 86 of the blade 82. As seen in FIGS. 10h and 10i, the loading edge 86 of the blade 82 and tapered portion 80 of the hex key 38 are not positioned in the cylinder 50, but the hex key 38 can slide axially within the cylinder 50 and the blade 82 can move buccolingually. However, the L-shaped portion of the hex key 38 on the proximal end 40 and the blade extension 90 on the distal end 44 keeps the body of the hex key 38 within the cylinder 50 after the snap locking of the blade 82 to the hex key 38.

At this point, and with respect to FIGS. 4-6a, the sectional matrix band 98 can be connected to the blade extensions 90. The matrix band 98 is flexible yet firm enough to maintain its shape when placed interproximally between teeth. It may be made of stainless steel or clear polymer with a thin band 92 of colored area along the gingival margin of the matrix to easily visualize its edge when placing. Also, different colors, other than red (which is the color of blood and gum tissue), can be used to distinguish different sizes and shapes of the matrix bands 98. The matrix band 98 includes two slit holes 102 proximate each corner thereof. The blade extensions 90 extending out of the exits 94 of the tine bodies 26 are inserted into the slits 102 to connect the matrix band 98 to the separator device 1 and keep the matrix band 98 in position against the pads 30 of the tine bodies 26 prior to the band 98 being positioned against a tooth that is to be restored. The gentle curve of the blade extension pathways 78 (FIG. 10h-10j) evens out the spring-back force exerted on the extensions 90 to prevent unwanted bending when the matrix band 98 (which may have a metal spring body) is spread out. The blade extension 90 may have a convex shape (like a tape measure) which helps keep it rigid when engaged with the matrix band 98. Further, with respect to FIG. 10h, the walls of the pathway 78 of the tine body 26 may be curved or define a convex shape to correspond to that of the blade extension 90 and provide guidance to the exit 94 and to prevent over-bending and promote more uniform stress distribution. Further, part of the tine body 26 wall facing the pad 30 is open to provide more room to accommodate flexing of the blade extension 90. With reference to FIG. 8, the pad 30 also contains a parabola-shaped concave section 106 to redistribute tension from the matrix band 98 when it causes the blade extensions 90 to flex.

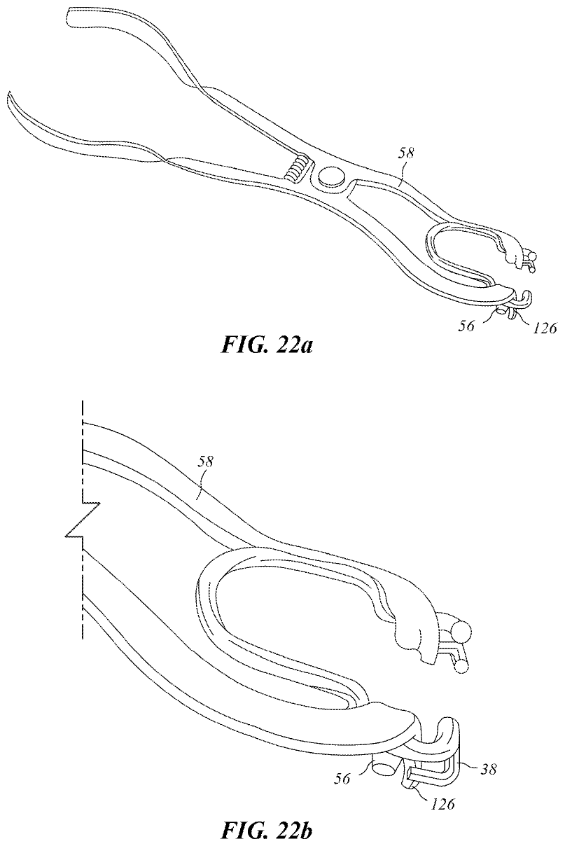

It should be noted that connection of the blades 82 to the device 1 and the connection of the matrix band 98 to the blades 82 can be done before inserting the device 1 in a patient's mouth. After the matrix band 98 is secured to the blade extensions 90, the device 1 can be used to position the matrix band 98 on the tooth needing restoration. With reference to FIGS. 22a and 22b, the user may use pliers 58 to insert the separator device 1 into the patient's mouth and position the matrix band 98. The pliers 58 include curved sections 56 that can be positioned in the notches 18 of the body 10 and, as shown in FIGS. 3 and 4, then the user can operate the pliers 58 to extend the legs 14, and thus the tine bodies 26, away from each other and expand the matrix band 98 for positioning between teeth and against the tooth needing restoration.

Once the matrix band 98 is positioned in place (as shown in FIGS. 5 and 7), the user can disengage the pliers 58 from the device 1, which allows restorative forces of the body 10 to spring the legs 14 back toward each other and to their original positions. As the legs 14 move back toward each other, each hex key 38 with the engaged blade 82 slides through the cylinder 50 buccolingually inside the tine body 26, causing the blade extensions 90 to be pulled away and withdrawn from the slits 102 of the matrix band 98. In addition, the restorative forces from the body 10 push the tine bodies 26 from proximal to distal, squashing the pads 30 on the tine bodies 26 against the tooth surfaces. As that happens, the parabolic shaped portion 106 of each pad 30 (FIGS. 8 and 9) is pushed into the exit 94 (FIGS. 9 and 10h) of the tine body 26, blocking the pathway 78 and thus preventing the portion of the blade extension 90 extending out of the exit 94 from moving into the pathway 78. This obstruction of the extension pathway 78 also restricts axial displacement of the hex key 38 in the distal-to-proximal direction. As shown in FIG. 7, when the device 1 is inserted, the lower portions of the legs 14 that are generally parallel to the center portion 12 lie below the occlusal plane at the gingival third.

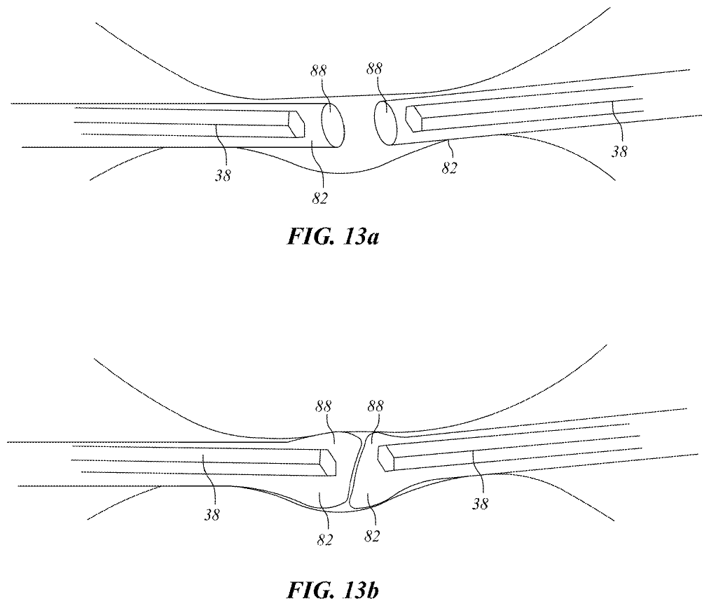

As shown in FIGS. 13a and 13b, after the matrix band 98 is placed between two teeth, the user pushes the hex keys 38 and blades 82 into the proximal space between the teeth, sliding along the gingival surface of the matrix band 98. With reference to FIG. 21, hex blade pliers 62 may be used to maneuver the L-shaped hex key 38 in and out of the tine bodies 26. The angled part of the hex key 38 resting on the proximal side 40 of the tine body 26 secures the blade 82 and prevents it from falling out of the cylinder 50. As discussed above, and with respect to FIGS. 13a and 13b, the tip 88 of the blade 82 is made of a softer elastic polymer, so when two opposing blades 82 are pushed inwardly from the tine bodies 26 toward and against each other, the elastic tips 88 of the blades 82 compress, filling up space between the teeth and pushing the matrix band 98 toward the concavity of the tooth surface, creating a tighter seal.

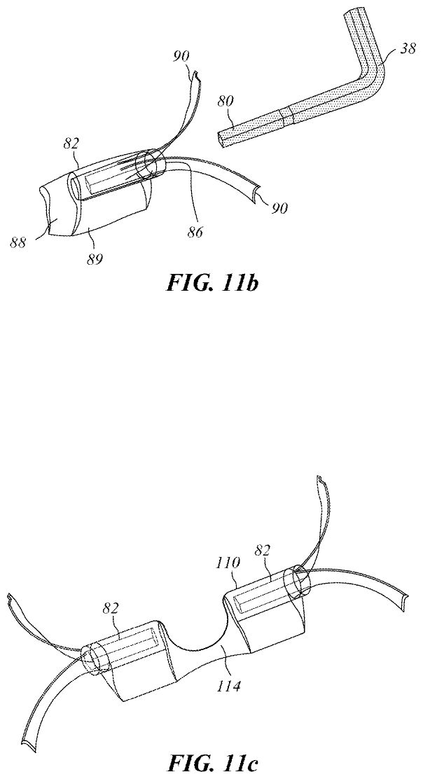

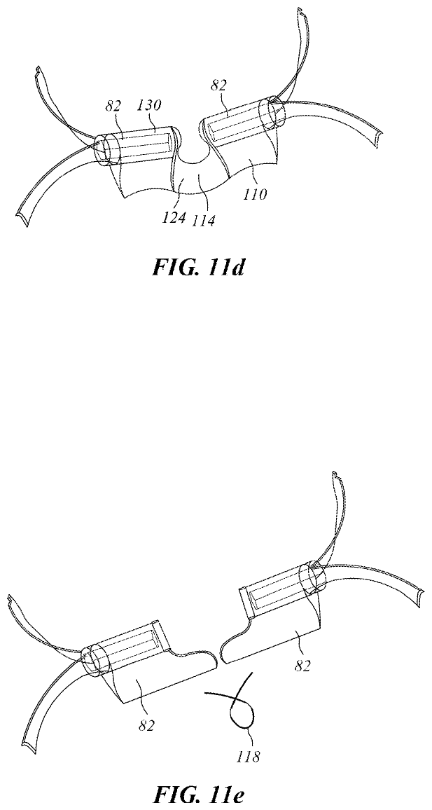

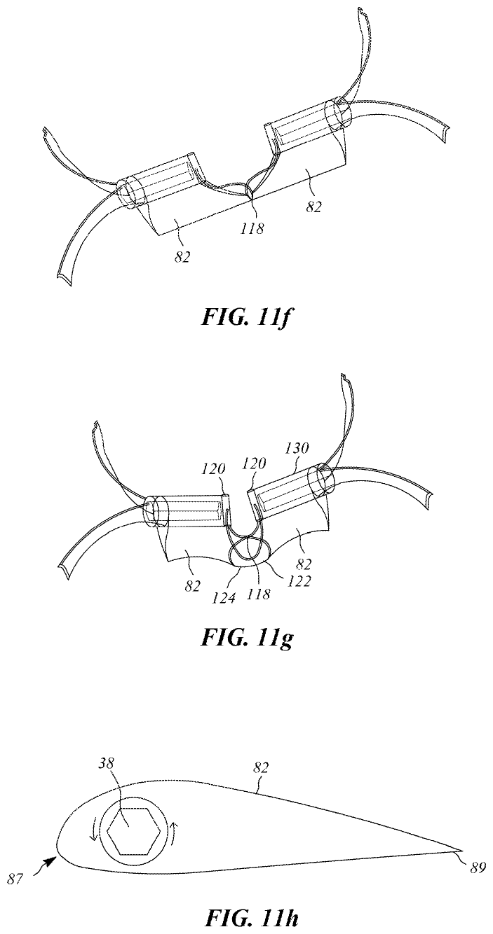

Alternatively, and with reference to FIGS. 11c and 11d, a double blade 110 can be used with the two tine bodies 26 instead of two single blades. The double blade 110 includes two blades 82 that are connected by a U-shaped arch 114. The arch 114 may be made of a medical-grade silicone rubber, polymer, or any other synthetic material that provides a sufficient tensile strength when it is stretched out and slides between two teeth. While the extended legs 14 of the body 10 spring back toward each other to securely position the matrix band 98 on the patient's teeth during insertion of the band 98, the arch 114 provides restorative forces that retract its two blades 82 together (as shown in FIG. 11d) under the contact area of two teeth. As another option for a double blade, and with reference to FIGS. 11e-11f, two blades 82 may be connected by a teardrop keyhole loop connector 118. Tubes 120 accommodate and retain ends of the connector 118. The connector 118 may be made of stainless steel, or an alloy thereof, in order to provide an elastic property that retracts two blades 82 together, as shown in FIG. 11g. Superimposed blade ends 122 define a convex blade edge 124 and provide additional mass to push the matrix band 98 even more toward the concavity of tooth surface below the gingival margin. The use of the pliers 58 to expand the legs 14 away from each other during the insertion process resists any relapsing force from the U-shaped arch connector 114 or teardrop keyhole loop connector 118 applied on the hex keys 38 until the device 1 is securely placed on the patient's dentition.

In operation, the blades 82 of the double blade 110 embodiments shown in FIGS. 11a-11g support the gingival third of the sectional matrix band 98, and the blade extensions 90 support the middle third of the matrix band 98 in relation to the separator device 1 when the pliers 58 are being used to expand the legs 14 away from each other as discussed above. At the same time, and with reference to FIGS. 22a and 22b, straight sections 126 of the pliers 58 can be used to engage the angled parts of the hex keys 38 (which are locked to the blades 82) to prevent recoiling of the arch 114 or connector 118 while the pliers 58 are being used to expand the body 10. In particular, the straight sections 126 of the pliers 58 holding the hex key 38 resist the recoil force from the u-shaped arch connector 114 or the teardrop keyhole loop connector 118, preventing the axial movement of the hex key 38 in the proximal-to-distal direction. With respect to the U-shaped arch connection 114, when it is stretched out (due to its elastic nature) during the insertion process, the arch 114 becomes sufficiently thin to navigate through interproximal contacts, both at the coronal and gingival levels.

After the matrix band 98 is positioned in the proximal space on a tooth, and the pliers 58 are removed and the legs 14 spring back toward each other, the U-shaped arch 114 and connector 118 of the double blade 110 embodiments recoil to form convex blade edges 124 as shown in FIGS. 11d and 11g, creating curvature that pushes the blades 110 more firmly into the gingiva.

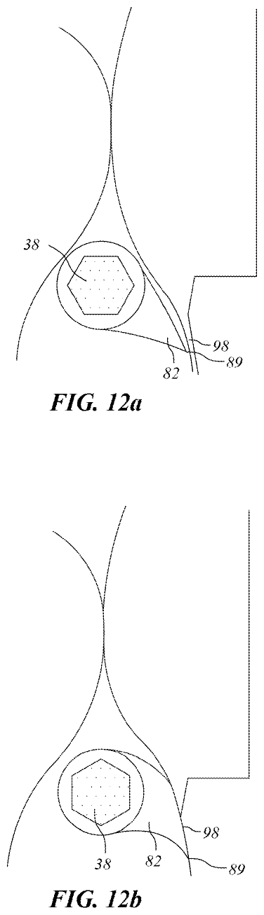

Once the matrix band 98 has been placed in position and the hex keys 38 and blades 82 have moved toward each other between the teeth to create space for the matrix band 98 and apply pressure against the matrix band 98 to seal it about the tooth needing restoration, the gear systems can be used to rotate the blades 82 to further seal the matrix band 98 along the gingival line of the tooth. In that regard, the user can rotate the gear knobs 34 (shown at FIGS. 1-3, 5, 7, and 10-1j), which, as discussed above, in turn, via the worm gear system, cause the hex keys 38 to rotate. With respect to FIGS. 12a and 12b, as a hex key 38 rotates, for example, in the counter clockwise direction, it causes the blade 82 (including the trailing edge 89) in which it is inserted, and locked to, to rotate up against the matrix band 98 along the gingival line and thus create a tighter cervical seal of the band 98 against the tooth surface. When the double blade 110 is used, the arch 114 creates a spring back force to bring two blades together while rotating against the tooth surface.

The ability to rotate the blades 82 to form a cervical seal eliminates the need to select different sizes of wedges in the conventional wedge matrix system, which is done to account for the fact that most posterior teeth exhibit varying contour angles on the buccal and lingual aspects, respectively. Further, the use of the two gear systems in two tine bodies 26 that operate and move independently of each other provides better adaptability around the cervical margin of the matrix band 98 than conventional wedge systems, which only provide a seal on either buccal or lingual sides of the teeth. Indeed, some posterior teeth may have a deep liner concavity on the proximal surface, under the contact area of the two teeth, and a conventional wedge system often leaves the cervical seal open or loose with the matrix band 98. Further, unlike conventional wedge and sectional matrix systems, the amount of force exerted on the lingual and buccal aspects of the sectional matrix band 98 by the device 1 can be controlled by the rotation of the hex keys 38 (and thus the blades 82) from opposite tine bodies 26. In addition, by inserting hex keys 38 toward each other between adjacent teeth and rotating them (which creates the lever effects between these teeth), the device 1 allows a user to create additional space between the teeth to compensate the thickness of the matrix band 98. It should be noted that other mechanisms besides gear systems can be used to cause the blades to rotate such as lever mechanisms, alternative rotational systems, or even proximal blade configurations that do not rely on a rotating/gear feature. Further, a shaft having a shape other than a hex key can be used to extend through the tine bodies and/or engage and rotate blades.

FIG. 10k shows an alternative gear system that can be used in the tine bodies 26. It includes a ratchet wheel 130 mounted to the cylinder 50 and a spring-loaded pawl 134. The hex key 38 is received in the cylinder 50, and the ratchet wheel 130 engages the pawl 134. A hex blade holder 62 (as shown in FIG. 21) can be utilized on the proximal end of L-shaped hex key to rotate the hex key 38. The operating direction of the hex key 38 rotation is determined by the interaction between the ratchet wheel 130 and the pawl 134. In particular, a user can use the hex blade holder 62 to turn the hex key 38 (and thus rotate the blade 82 to engage the matrix band 98 to further seal the band 98 against the tooth as shown in FIGS. 12a and 12b). As the hex key 38 turns, the ratchet wheel 130 turns with it and against the pawl 134, and when the user stops rotating the hex key 38, the pawl 134 engages the ratchet wheel 130 to prevent it from rotating and thus locks the hex key 38 and blade 82 in place.

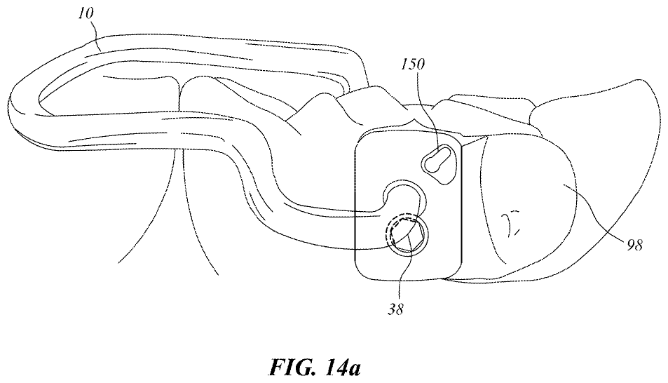

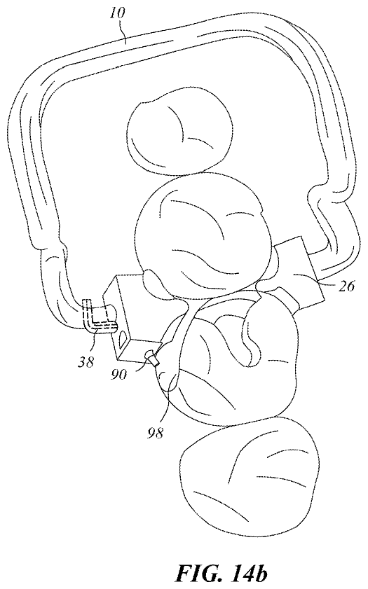

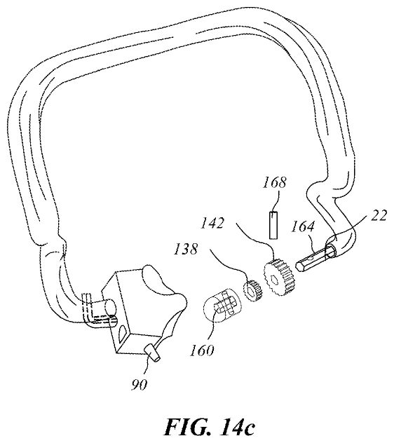

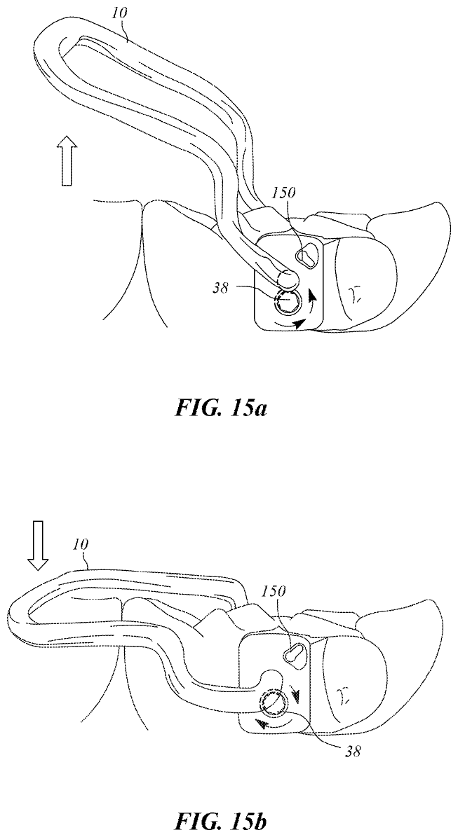

Another alternative gear system that uses a ratchet system is shown in FIG. 14-15 and 17. The system includes first and second spur gears 142 and 146, a ratchet wheel 138, and a pawl 134 to transfer a torque created by the vertical movement of the body 10 (as shown in FIGS. 15a and 15b) through the hex key 38 connected to the blade 82 in the proximal space. The spur gears 142 and 146, ratchet wheel 138, and pawl 134 may be made of stainless steel, titanium, or an alloy thereof. In this system, the distal end or tine 22 of each leg 14 that extends into the tine bodies 26 is connected to the first spur gear 142. The second spur gear 146 is mounted to the cylinder 50 that receives the hex key 38. The tines 22 are generally parallel to the central portion of the body 10 and may be received in bearings or bushings in the compartments 28 to reduce friction on the tines 22. Alternatively, the tine body compartments 28 can be made of a polymer like PTFE-filled PEEK or a glass fiber composite, which can also act as a dry bearing/bushing to reduce friction against the tines 22, cylinder 50, and/or the spur gears 142 and 146, and, thus, eliminate the needs of separate components like bearings or bushings. The direction of the hex key 38 rotation is dictated by a reversion (or torque wrench) lever 150 (as shown in FIG. 14a), which controls the pawl 134 (as shown FIG. 17).

In operation, the user can use the reversion lever 150 to set the pawl 134 such that it allows the ratchet wheel 138 (and thus the first spur gear 142) to rotate in one direction, for example, counter clockwise. The user can then move the body 10 upward and downward (as shown in FIGS. 15a and 15b), which causes the tines 22, and thus the first spur gears 142 to rotate counter clockwise. The first spur gears 142 engage the second spur gears 146 and cause the second spur gears 146 and, thus the hex keys 38, to rotate clockwise. The rotation of the hex keys 38 causes the blades 82 to rotate toward the matrix band 98 and create a tighter cervical seal against the tooth surface (as shown in FIGS. 12a and 12b). Thus, the pawl 134 allows movement in one direction on the first spur gear 142 while preventing backlash, like a ratchet or torque wrench. Also, the force on the body 10 during the ratcheting operation generates a lever effect against the matrix band 98 on the cervical margin of the tooth, pushing two adjacent teeth apart, creating more proximal space. Any forces generated by either a gear system or a lever should not create tension or compression great enough to create permanent damage on the periodontal ligament or tooth structure, and yet it should be enough to increase the proximal space temporarily. To release the first spur gear 142, the user can move the reversion lever 150 to another position that causes the pawl 134 to disengage from the ratchet wheel 138 so that the first spur gear 142 can rotate in a direction opposite of the first direction.

With reference to FIG. 14c, the gear system may include a dome-shaped nut 160 at the distal end. The system further includes a hex extension 164 extending from the tine 22, which passes through bores of the first spur gear 142 and the ratchet wheel 138 and into the nut 160. A cross-pin 168 can be inserted through transverse holes in the nut 160 and the hex extension 164, which prevents the first spur gear 142, ratchet wheel 138 from sliding off the hex extension 164.

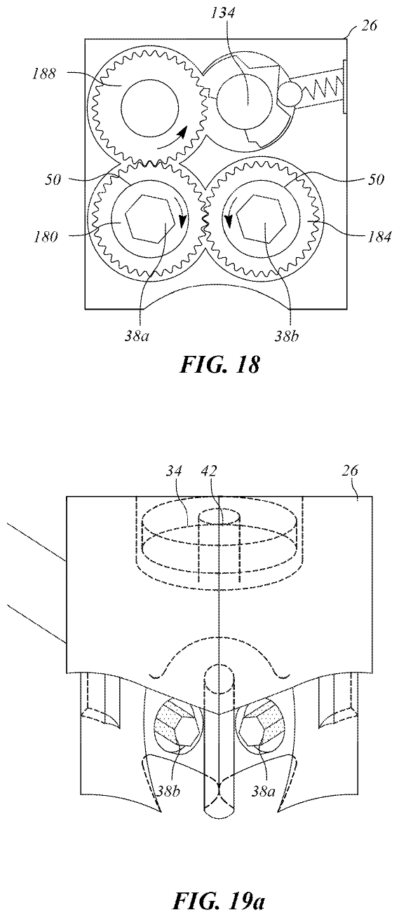

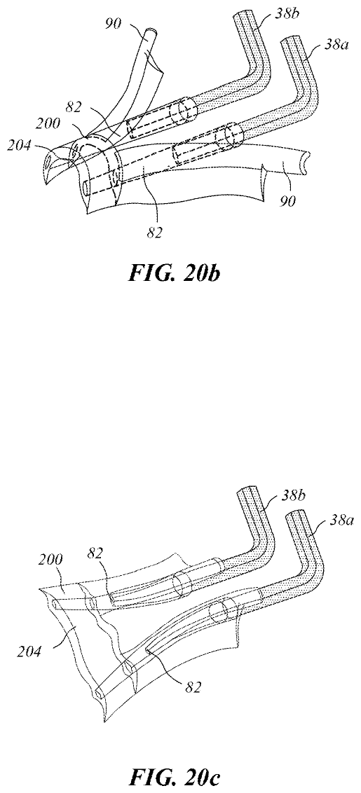

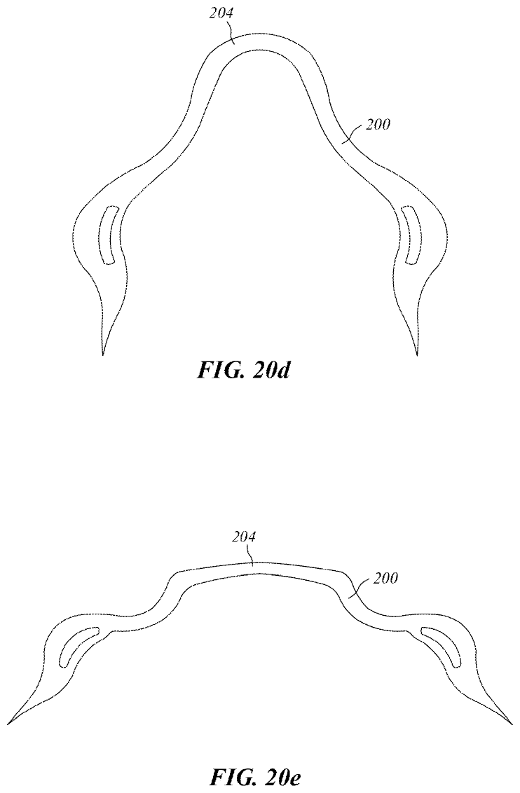

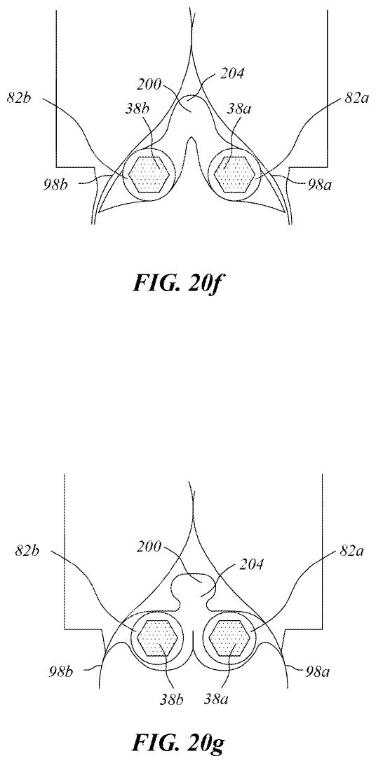

With reference to FIGS. 18 and 19a-19f, and 20a-20g, other tine body gear system embodiments are configured to work with a double blade system that can be used to engage two matrix bands on adjacent teeth to restore two adjacent proximal tooth surfaces simultaneously. With reference to FIGS. 20a-20c, the double blade system 200 includes two generally parallel blades 82 connected by a flexible arch 204. The arch 204 allows the two blades 82 to be stretched out away from each other (see FIG. 20e) for a tighter seal of matrix bands 98 on adjacent teeth. The blades 82 have extensions 90.

With reference to FIGS. 18 and 20a-20g, one embodiment of a gear system for the double blade system 200 is a ratchet system similar to that shown in FIG. 17 that includes spur gears 180, 184, and 188, where spur gears 180 and 184 are connected to parallel cylinders 50 that are configured to receive double hex keys 38a and 38b that are part of double blade system 200. Like the single blade system described above, the extensions 90 of the double blade system 200 are placed in pathways in the tine body 26 and the two loading edges of the system are positioned outside of two generally parallel cylinders 50 in the tine body 26. The two hex keys 38a and 38b are inserted into the cylinders 50 and into the loading of the double blade 200 and snapably connected to them. With respect to FIGS. 14a, 14b, 15a and 15b, after the device 1 is used to position the matrix band 98 in place, the user can move the center portion 12 up and down, which causes gear 188 to rotate in a counterclockwise direction, which in turn causes spur gear 180 (and thus hex key 38a) to rotate clockwise. As shown in FIG. 20f, this movement by hex key 38a causes the blade 82a to rotate up against a first matrix band 98a positioned on a first tooth. The clockwise rotation of spur gear 180 further causes spur gear 184 (and thus hex key 38b) to rotate in a counterclockwise direction. As shown in FIG. 20g, this movement by hex key 38b causes the blade 82b to rotate up against a second matrix band 98b positioned on a second tooth proximate the first tooth. A ratchet wheel can be mounted on the same shaft as the first spur gear 180 (as shown in FIG. 14c) and the ratchet wheel can engage the pawl 134 in a way similar to that described for the embodiment shown in FIG. 17.

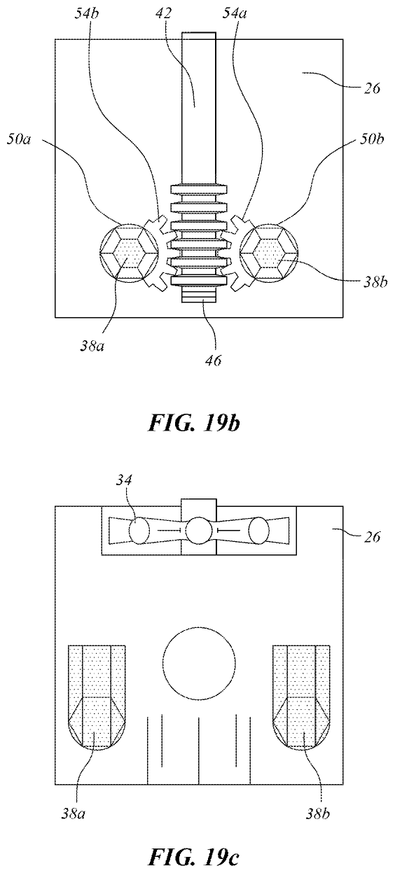

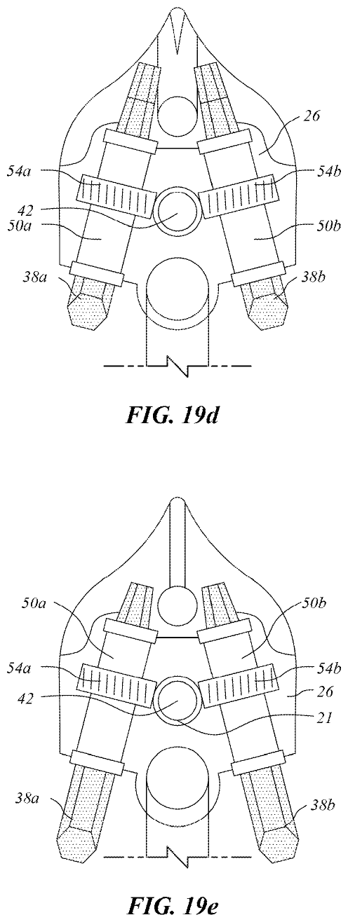

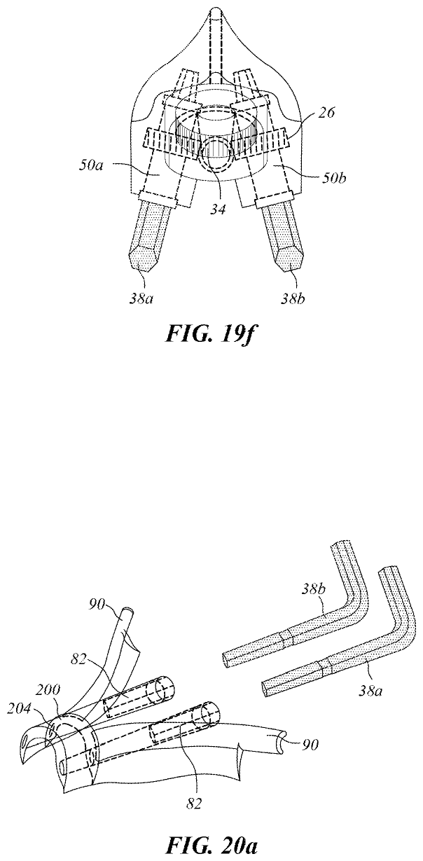

With reference to FIGS. 19a-f, another embodiment of a gear system for the double blade system 200 is a worm gear system similar to that shown in FIGS. 10a-10j. The tine body 26 includes two cylinders 50a and 50b that are at an angle to each other. They receive the hex keys 38a and 38b, respectively, such that tapered ends of the hex keys 38a and 38b extending out of the distal side of the tine body 26 are closer to each other than the angled ends of the hex keys 38a and 38b extending out of the proximal side of the tine body 26. In operation, the hex keys 38a and 38b are snapably connected to the loading edges of the double blade 200. Each cylinder 50a and 50b has a worm wheel 54a and 54b mounted to it. The shaft 42 has a worm 46 and is positioned between the cylinders 50a and 50b. When the gear knob 34 is rotated, the shaft 42 and worm 46 rotate, which causes the cylinders 50a and 50b (and thus the hex keys 38a and 38b) to rotate. As shown in FIGS. 20f and 20g, this rotation by the hex keys 38a and 38b causes the blades 82a and 82b to rotate up against the first and second matrix bands 98a and 98b, respectively, positioned on the adjacent first and second teeth.

Rotating two hex keys 38a and 38b inward in relation to each other as shown in FIGS. 20f and 20g generates a downward force on the arch 204 of the double blade 200, creating thrust in the arch 204 to diverge the blades 82 away from each other, like an arch bridge. This additional force created by the arch 204 can serve to increase proximal space to accommodate added thickness of two matrix bands 98a and 98b, especially with bands made of polymer, which are usually thicker than bands made of metal.

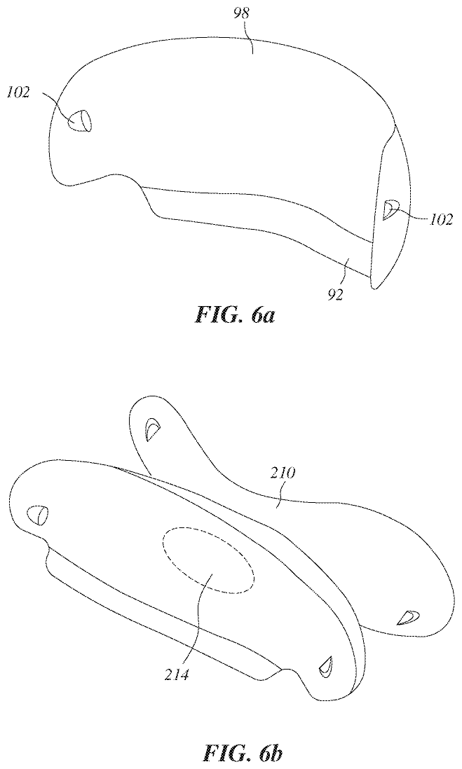

In another embodiment, a double matrix 210, as shown in FIG. 6b, can be used with the aforementioned double blade systems 200 to reduce the amount of space taken up by two separate matrix bands 98. The double matrix 210 has a broad contact area of a bonded surface 214, which is thinner than having two separate matrices band 98 aligned next to and against each other.

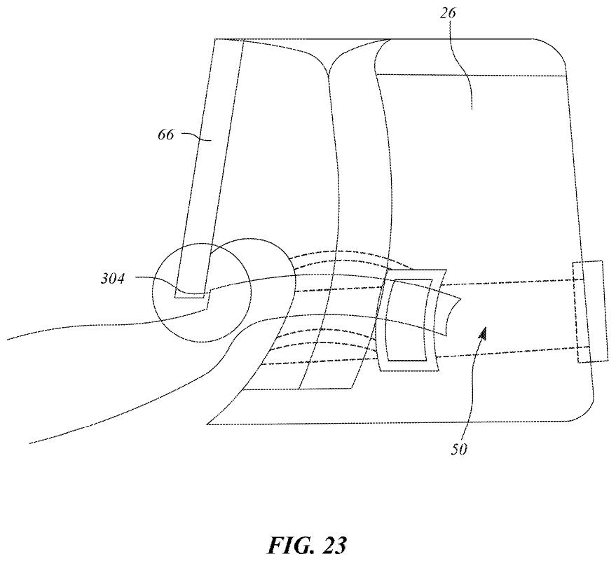

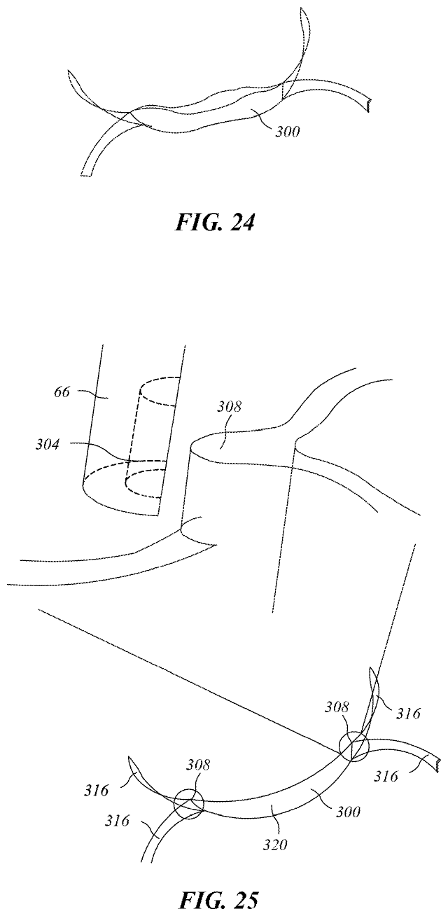

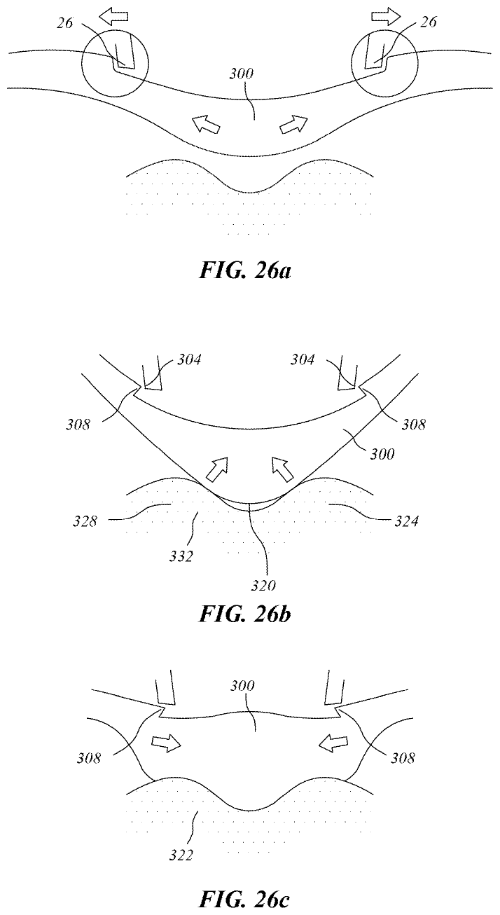

In another embodiment, and as shown in FIGS. 23-26, the tine bodies 26 do not include a gear system and operate with a flexible double blade system 300. The distal side extension 66 of the tine body 26 defines a notch 304. By way of example only, the notch 304 can be U-shaped but can also have other shapes. The blade system 300 includes a head 308 that can be retainably and releasably engaged by the notch 304. By way of example only, the head 308 can be U-shaped but can also have other shapes, including shapes that correspond to the shape of the notch 304. Each head 308 is at the point where the blade extensions 316 diverge from the body 320 of the blade 300. The heads 308 provide resistance to the recoil force generated by the U-shaped arch connector 114 or the tear drop key connector 118 (see FIGS. 11c-11g) of the blade 300. With reference to FIG. 26a, this arrangement holds the blade 300 securely in place between opposing tine bodies 26 while the separator 1 engages the matrix band 98 and stretches the blade 300 (as shown by the arrows) as discussed above. With reference to FIG. 26b, as the two tine bodies 26 approximate near the proximal surfaces of the teeth (not shown), the blade heads 308 on of the bodies 26 on each side gradually slide out of the notches 304. At the same time, the blade 300 recoils, bowing into a convex shape directed toward the concave space 320 defined by the buccal side 324 and lingual side 328 of the gingival tissue 332. A slight upward pressure from the gingival tissue 332 against the blade 300 (as shown by the arrows) causes the heads 308 to snap free from the notches 304. With reference to FIG. 26c, once the blade 300 is released from the tine body notches 304, the absence of resistance allows the recoil force (as shown by the arrows) to redistribute mass toward the center of the blade 300, thereby securing the matrix band (not shown) in position against the tooth.

In another embodiment, the body 26 may include a tube that is configured to allow for the blade 300 to be engaged such that the blade 300 pushes against the matrix band. This could be done in situations, for example, where the blade 300 does not recoil or is stuck or to further secure the blade 300 against the matrix band. For example, with respect to FIG. 23, the tube could be a cylinder 50 as discussed above, which receives and accommodates a hex key and can also provide a path for a rod or pin inserted axially to push the blade 300 distally if it becomes stuck.

As explained above, the separator ring of the different embodiments includes a stretchable elastomeric component (e.g., a blade) that is temporarily attached to the distal ends of both tine bodies. During placement, pliers are used to spread the tine bodies apart. This spreading action stretches the elastomeric component, causing it to elongate and thin in the buccolingual direction, which allows the elastomeric component to pass through a narrow interproximal space that would otherwise not accommodate its unstretched thickness. Accordingly, and advantageously, the separator ring itself is used to stretch and actuate the elastomeric components that secure the matrix band, rather than having to use additional pliers to directly stretch or manipulate elastomeric components.

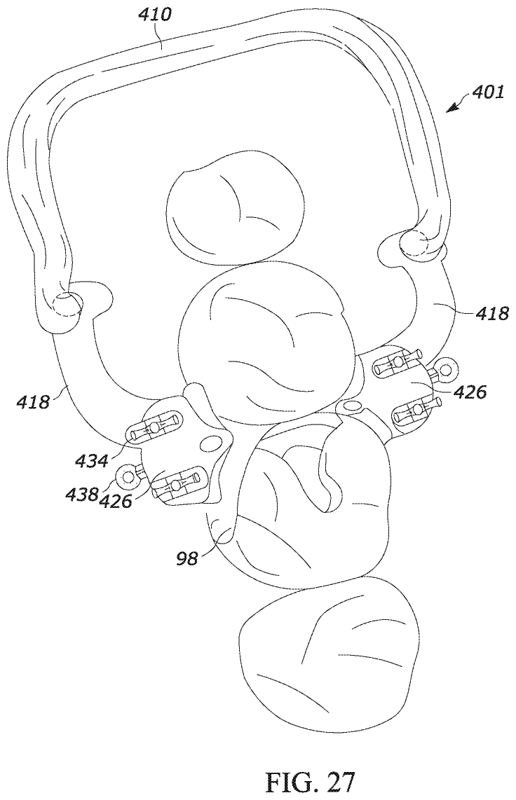

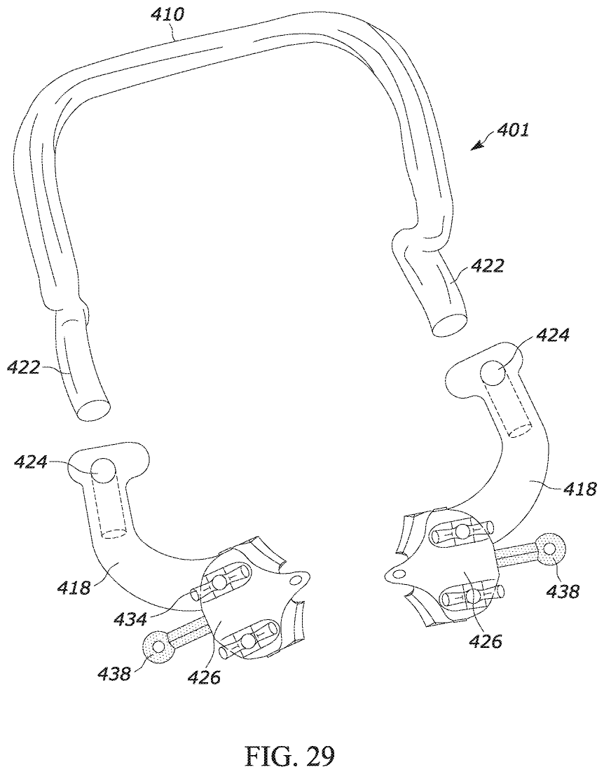

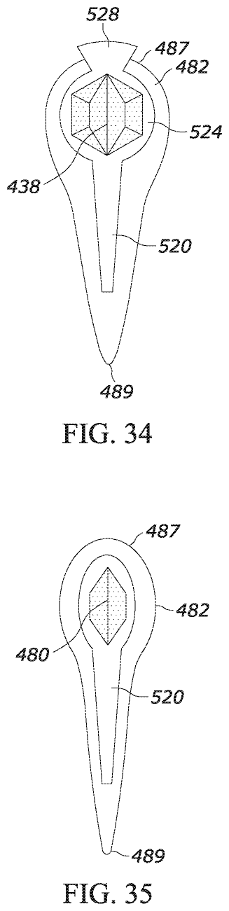

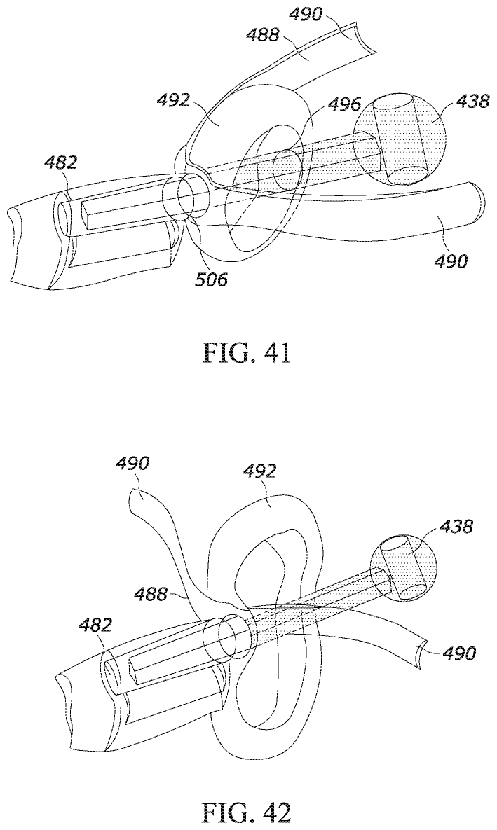

Another embodiment of the present technology is shown at FIGS. 27-49. As shown in FIGS. 27-29, the body 410 of the ring separator 401 may include tines 422 configured to be connected to curved arms 418 that define C-shaped notches and that are each connected to a tine body 426. The tine bodies 426 may be elastomeric and may be heat-treated to permanently bond to the L-shaped tine 422 ends to the bodies 426. Also, the L-shaped tine 422 end creates clearance for placement of an additional ring separator on the adjacent tooth in a stackable manner. The notches allow for the use of pliers to engage the ring separator 401 in order to place the matrix band 98 between adjacent teeth and against the tooth needing restoration. The ring separator 401 applies a controlled force to the matrix band 98 that temporarily deforms/flattens the elastomeric or metallic matrix band 98, enabling a straight, vertical path of insertion through the interproximal space. The tines 422 are received in openings 424 at top distal ends of the arms 418. Once heat treated, the tines 422 may be permanently secured to the bodies 426 and cannot disengage from them, and the L-shaped tine 422 ends help stabilize the position of the bodies 426.

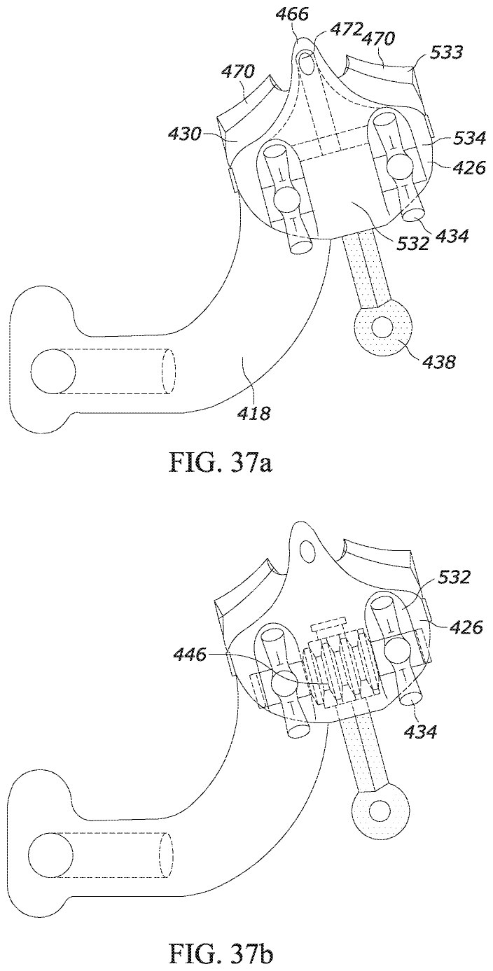

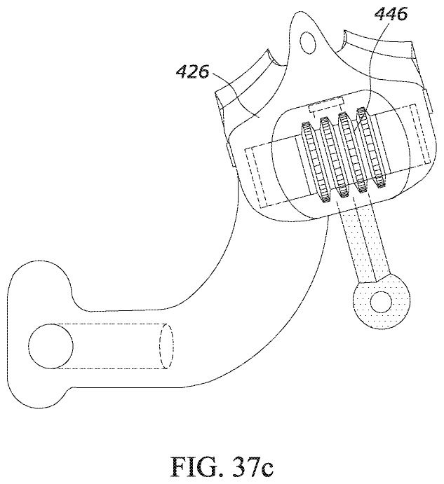

With reference to FIGS. 37a, 40 and 48-49, each tine body 426 includes a distal compartment portion 533 that may receive and be fused to a relatively flexible pad 430. The fusion may be achieved through a heat-treatment process that results in a permanent metallurgical bond while preserving the flexibility of the pad 430, or through chemical or pressure bonding. A proximal compartment portion 534 includes the curved arm 418 that may be permanently bonded to the tine body 426 via heat treatment. The curved arm 418 and the proximal compartment portion 534 may be one piece. The tine ends 422 may be permanently bonded to the curved arm 418 through the openings 424 via heat treatment. The distal compartment 533 and the proximal compartment 534 may be manufactured and heat-treated separately, and may be subsequently assembled together, optionally using a mechanical fastener such as a screw or equivalent attachment mechanism or chemical/pressure bonding. When assembled, the two compartments cooperatively define an internal housing 532 configured to receive and support a worm gear system and one or more handling knobs. In that regard, each tine body 426 includes at least one gear knob 434 and a stop or hex key ball 448 on a proximal side thereof and receives a driving member that can be a shaft or hex key 438 and hex blade 482 on a distal end thereof. The tine bodies 426 are configured to be connected to a matrix band 98.

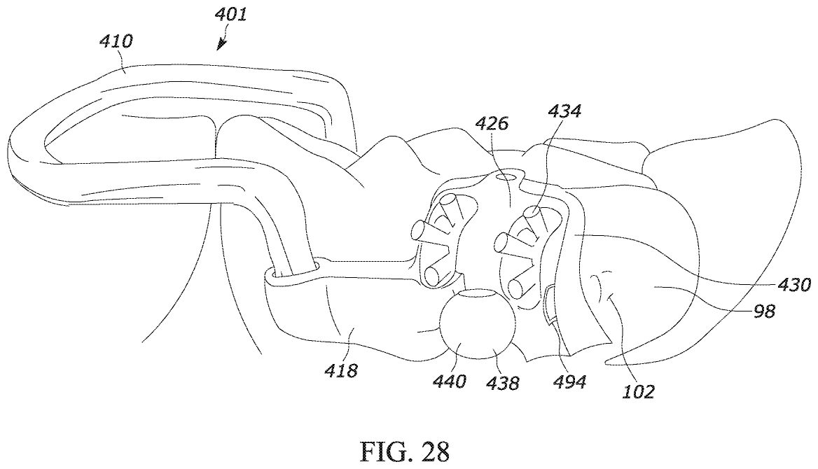

With reference to FIGS. 27 and 28, the matrix band 98 is inserted along a tooth needing restoration. With reference to FIGS. 28 and 29 and 32, the tine bodies 426 include exits 494 and pads 430 positioned between the teeth and the tine bodies 426. Similar to the embodiments discussed above, arch leaf spring ends 490 extend out of the exits 494 and are inserted into the slits 102 of the matrix band 98 to connect the matrix band 98 to the ring separator 401 and keep the matrix band 98 in position against the pads 430 of the tine bodies 426 prior to the band 98 being positioned against a tooth that is to be restored. Also, as discussed in more detail below, rotation of the hex key 438 causes a trailing edge 489 of the blade 482 to tilt slightly toward the apical edge of the matrix band 98 along the gingival margin band 92 (FIG. 6), thereby providing an additional contact surface to secure the matrix band 98 against the pads. The hex key in the various embodiments disclosed herein may be made of a softer material than the tine bodies of the various embodiments and/or any engaged coupling feature connecting the hex key and tine body such that use of the hex key reduces the likelihood of damage to the tine bodies and/or the engaged coupling feature.

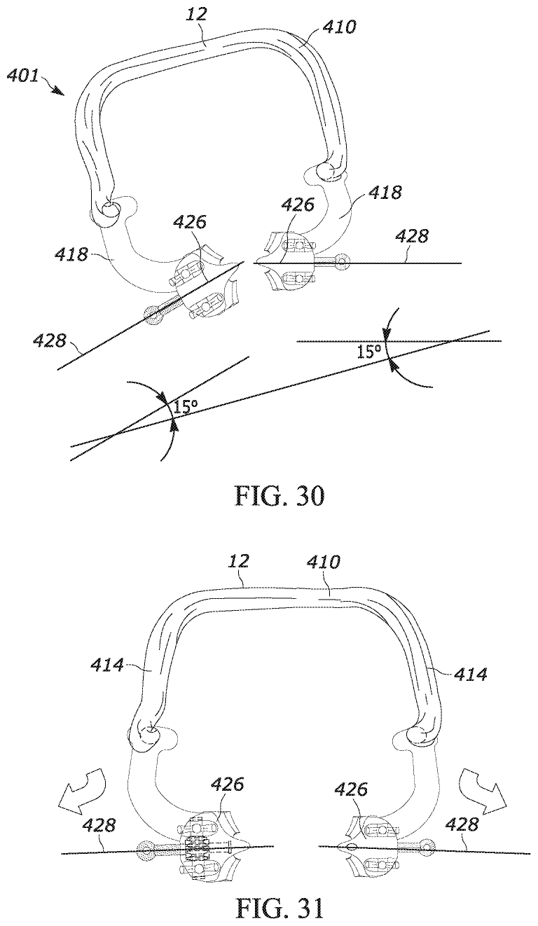

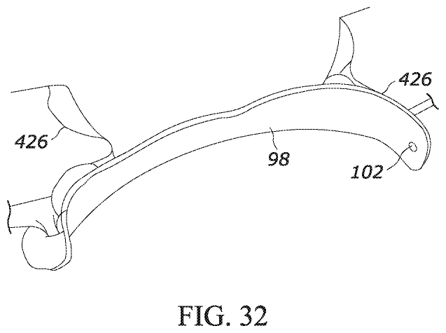

With reference to FIG. 30, the arms 418 may be curved such that an axis 428 extending through the side of each tine body 426 is at a non-parallel angle to the handle 12 of the body 410 when the ring separator 401 is in a non-flexed state. In particular, each tine body axis 428 may be at about a 15-degree angle to the handle 12; however, the angle may vary depending on the stiffness characteristics of the ring separator 401. Alternatively, the axes 428 may be at larger or smaller angles to the handle 12. With reference to FIG. 31, flexing the legs 414 changes the orientation of the tine axes 428 such that the axes 428 may be generally parallel or slightly angled with respect to each other depending on the degree of flexure and/or the position of the matrix band 98. This allows the band 98 to be positioned before application without permanent deformation. Further, that each tine body 426 may be angled slightly inward when the body 410 in the non-flexed position compensates for the outward flexing when the legs 414 are pulled apart such that the tine bodies 426 may form a generally straight buccolingual path of insertion for the matrix band 98 between adjacent teeth when the legs 414 are pulled apart, as shown in FIG. 32.

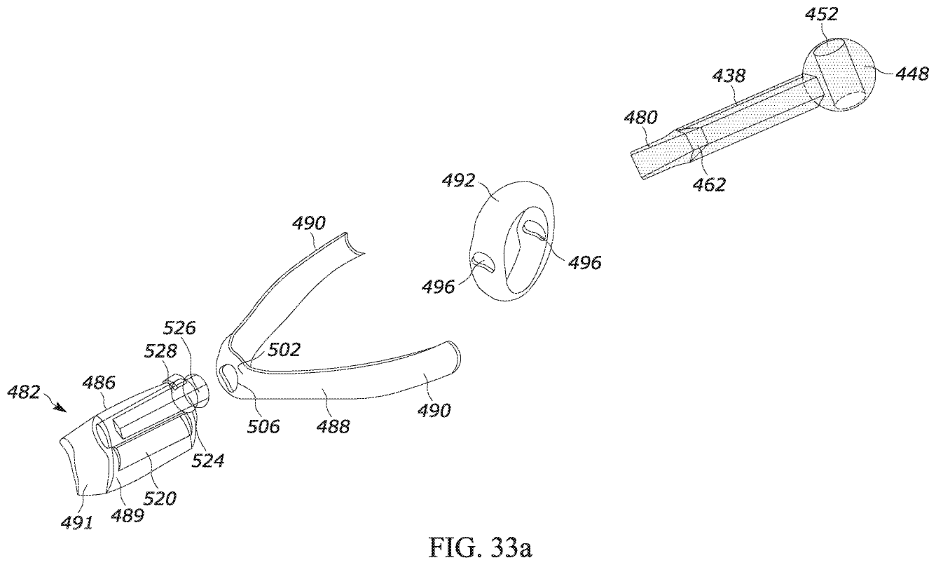

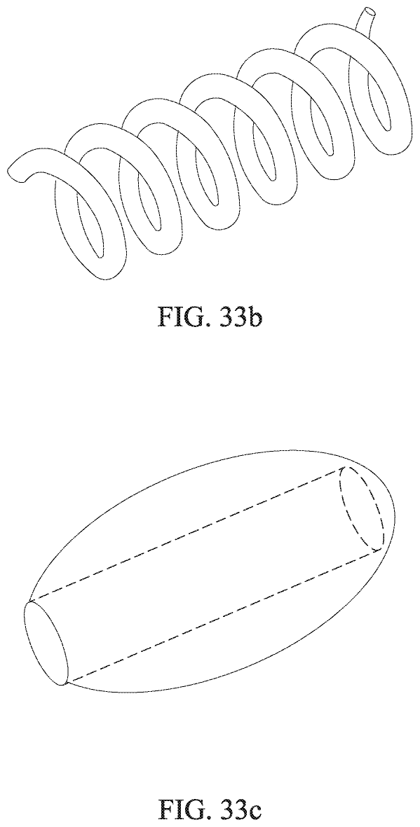

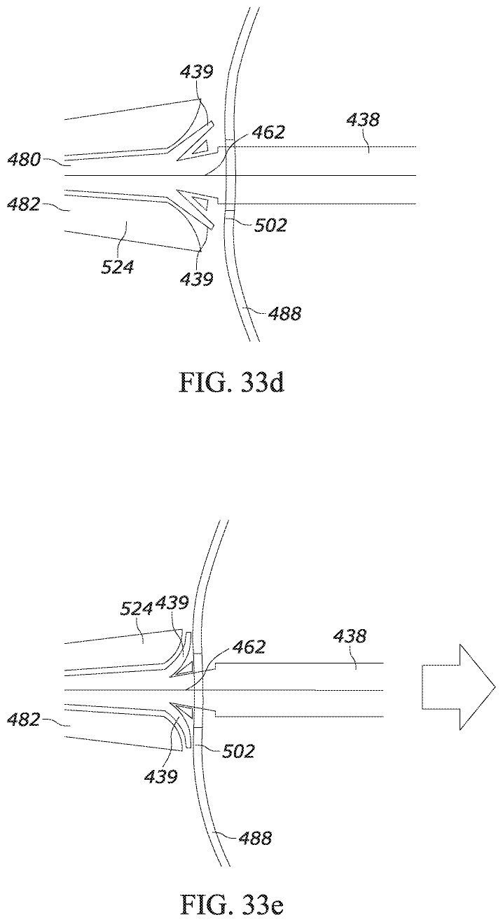

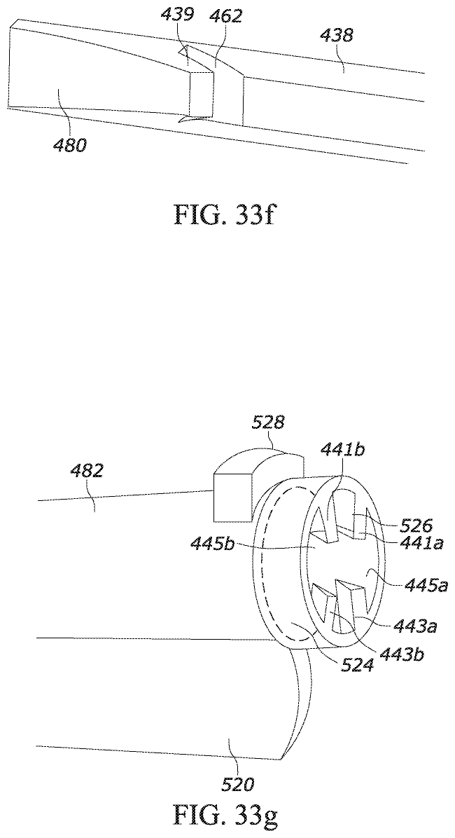

FIG. 33a shows an exploded isometric view of a blade 482, leaf spring 488, ring spring 492, and shaft or hex key 438 that can be used with the ring separator 401 and matrix band 98 of FIGS. 27-32 to insert the matrix band 98 around a tooth needing restoration. The hex key 438 differs from the hex key in other embodiments by having a ball 448 at its distal end opposite the tapered end 480, and the ball 448 has a hole 452 extending therethrough generally perpendicular to a longitudinal axis of the shaft of the hex key 438. The ball 448 prevents the hex key 438 from sliding out of the tube 50 of a tine body 426 in the distal direction by serving as a stop/anchor against the proximal end wall of the tine body 426 when the hex key 438 is inserted in the tube 50. The hole 452 can receive an instrument (such as a dental explorer or probe) so that the position of the hex key 438 can be pulled/moved with respect to the tine body 426.

The oval-shaped ring spring 492 is a flexible member and may be made of an elastic metal alloy or other flexible material and has ports 496 at apex ends thereof that are configured to receive the hex key 438. In its resting position, as used in this embodiment, the ring spring 492 may be a slightly elongated ring oriented in the proximal-distal direction. The ring spring 492 may be formed as a slightly curved mini c-channel, with the concave sides facing each other to increase recoil force. Alternatively, as shown in FIGS. 33b and 33c, a wave spring, coil spring, or “football shaped” (prolate) elastomer element can be used in place of the ring spring 492. The flexible leaf spring 488 may be made of stainless steel or another elastic metal alloy (or a combination thereof) to provide recoil force like the blade of other embodiments and includes extensions 490. The leaf spring 488 has a small flat pad 502 at and surrounding an entry port 506 that, as discussed in more detail below, interfaces with diverged ends of a triangular flap 439 of a snap-in feature 462 of the hex key 438. When in a locked position, forces applied to the blade 482 promote further divergence of the flap 439, producing a self-reinforcing locking effect that resists loosening or disengagement of the blade 482 from the hex key 438. The leaf spring 488 is similar to the blade extension in other embodiments in that it has a convex shape (like a tape measure) which helps maintain rigidity when the leaf spring 488 is engaged with the matrix band 98 and is inserted in a pathway 478 in the tine body 426.

With reference to FIGS. 33-35, the blade 482 includes a tip 491, a loading edge 486, and a trailing edge 489 like blades in other embodiments. The blade 482 includes an extension 520 that supports blade movement and maintains the integrity of the blade geometry during rotation of the blade 482. The blade 482 also includes a rigid compartment 524 that is formed of a harder elastomeric material than the softer outer layer of the blade 482 and that is configured to receive the tapered end 480 of the hex key 438 and that includes a snap-in feature 526 that engages the snap-in feature 462 of the hex key 438 to lock the hex key 438 to the blade 482. The blade 482 further may include an extension 528 located coronal to (or on the top of) the blade 482 that is configured to engage a notch 604 on the tine body 426. The compartment 524 may provide structural support for the extension 528 and the extension 520. The compartment 524 may be formed of the same material as, and include, the extensions 528 and 520.

As shown in FIG. 33d-g, the snap-in feature 462 of the hex key 438 may include the triangular flaps 439 that open outward while remaining attached, with diverged ends bearing against the small flat pad 502 of the leaf spring 488. The flaps 439 may be formed by partial cuts formed vertically along opposing lateral sides of the snap-in feature 462, extending inward from an outer surface but stopping short of complete separation. When viewed from above or below, these partial cuts define a generally triangular flap 439 or segment on each side. In operation, the flat pad 502 surface area faces compartment 524 of the blade 482 around the entry. The hex key 438 is oriented with respect to the compartment 524 such that two opposing corners of the tapered end 480 are aligned along the apical-coronal direction. The snap-in feature 526 of the compartment 524 may include small flap-engaging hooks or wedge features 441a and 441b that extend vertically from the rigid compartment 524 on a coronal side, and two corresponding hooks or wedge features 443a and 443b that extend vertically from an apical side. The tapered end 480 and flaps 439 are inserted into the compartment 524 between the teeth 441a and 441b on the coronal aide and between the teeth 443a and 443b on the apical side, until the flaps 439 can expand and diverge outward and extend through gaps 445a and 445b of the snap-in feature 526. Thus, the hooks 441 and 443 are received within the cuts or recesses formed between diverged portions of the triangular flaps 439 and the body of the hex key 438, thereby providing snap-in engagement. When the hex key 438 is pulled back away from the compartment 524 (as shown in FIG. 33e), the flaps 439 engage the flat pad 502. When the triangular flaps 439 of the hex key 438 are positioned against the flat pad 502, applied pressure causes the flaps 439 to diverge outward further, thereby preventing direct contact between the flat pad 502 of the leaf spring 488 and the rigid compartment 524 of the blade 482 and thus, preventing dislodgement of the blade 482 from the hex key 438. This engagement helps prevent the blade 482 from loosening or disengaging from the hex key 438 when forces from the locked spring 492 or other elastomeric elements act against the rigid compartment 524 of the blade 482. Further, the leaf spring 488 is pre-bent and includes the flat pad 502, which seats against the compartment 524. The extensions 490 of the leaf spring 488 bend upon the hex key 438 being snapably connected to the compartment 524. From the flat pad 502, the leaf spring 488 curves outward, and the extensions 490 diverge into the pathway 478 of the tine body 426. Alternatively, other types of snapable or interlocking connectors can be used to connect the hex key 438 to the compartment 524 and/or to the blade 482.

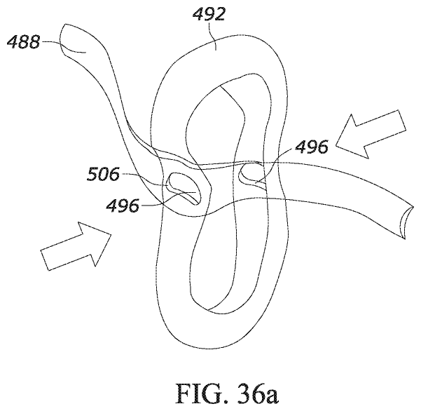

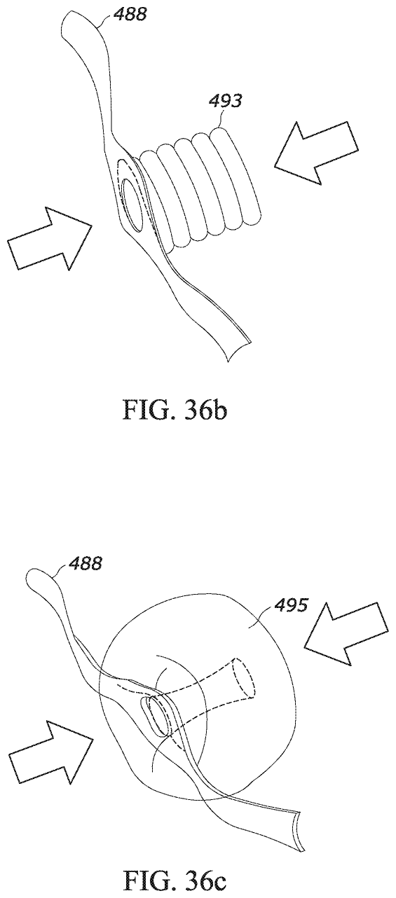

FIG. 36a shows how the ports 496 of the ring spring 492 can be aligned with the entry port 506 of the leaf spring 488 and how the ring spring 492 can be deformed/compressed when pressure is applied to it from one or both directions at, or along, the aligned ports 496. FIGS. 36b and 36c show other alternative embodiments of springs or elastomer components 493 and 495 that can be used with the leaf spring 488 in place of the ring spring 492. Structure 493 may be a type of coil spring and structure 495 may be a compressible elastomer material with a passage therethrough.

FIG. 37a illustrates a top view of a tine body 426 (with the distal part of the top of the tine body 426 cut away) and arm 418. The body 426 includes at least one gear knob 434 that can be rotated by a user's finger or a tool to cause a gear system inside of the tine body 426 to rotate the hex key 438 as will be explained in more detail below. As with other embodiments disclosed herein, the tine body 426 may include a base with bevelled extensions 470 that follow the contour of the positive emergence profile of the gingival third of a tooth crown, preventing the matrix band 98 and/or the ring separator 401 from popping out of the intended sites. Further, with respect to FIGS. 40, 48, and 49, the pad 430 can be positioned against the distal end of the tine body 426 and sit on and above the bevelled extensions 470. In addition, the tine body 426 may include an extension 466 and, proximate the extension 466, the tine body 426 may include an extension or button 472 of a cantilevered leaf spring 620 extending above the top surface of the tine body 426 and coupled to a vertically moving cylindrical rod or plunger extending through an opening or tube into the tine body 426. As discussed in more detail below, downward force applied to the button 472 can cause the plunger to disengage the extension 528 of the blade 482 from the notch 604 when the blade 482, leaf spring 488, ring spring 492, and hex key 438 are being used with the tine body 426.

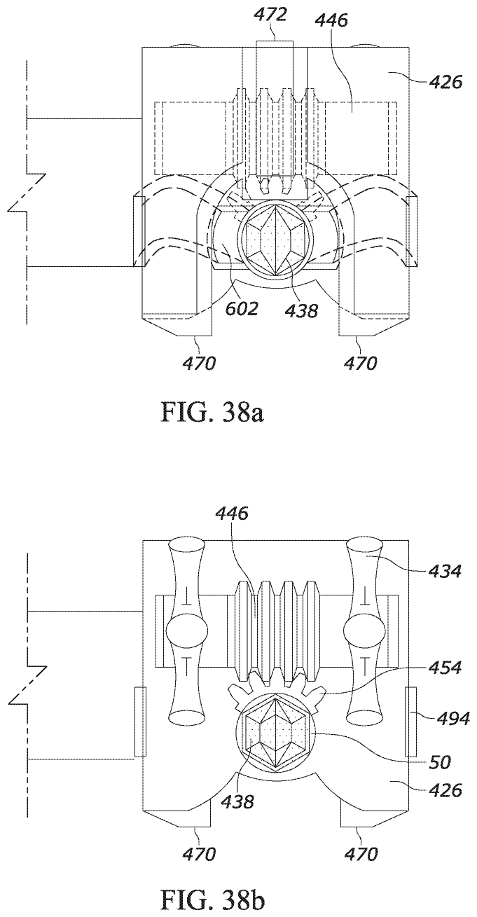

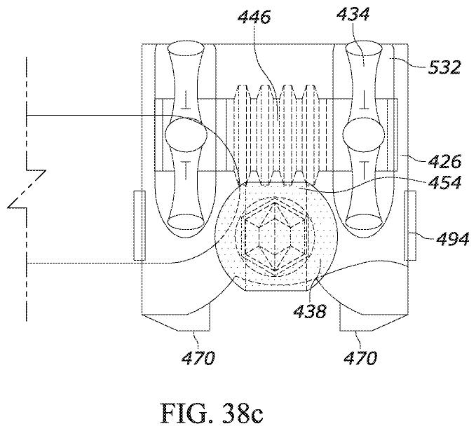

FIG. 37b shows a top view of the tine body 426 of FIG. 37a with a proximal portion of the top of the tine body 426 cut away. The tine body 426 includes an internal housing or compartment 532 that houses the knob(s) 434 and a worm 446 to which the knob(s) 434 are connected. With reference to FIGS. 38a-c, the cylinder 50 has the worm wheel 454 mounted to it. When the gear knob(s) 434 are rotated in compartment 532, the worm 446 rotates, which causes the worm wheel 454 and the cylinder 50 (and thus the hex key 438) to rotate. The tube/cylinder 50 may include an internal hexagonal surface configured to receive and rotationally drive the hex key 438, although other corresponding shapes may be used for the hex key and cylinder that allow the cylinder to rotate the hex key.

FIG. 37c shows an alternative to the tine body 426 shown in FIGS. 37a-b in which the gear system does not include knobs 434. Rather, the worm 446 may be exposed and rotated directly with a finger or tool to drive rotation of the worm wheel 454. To increase traction, multiple threads may be formed on the teeth of the worm 446.

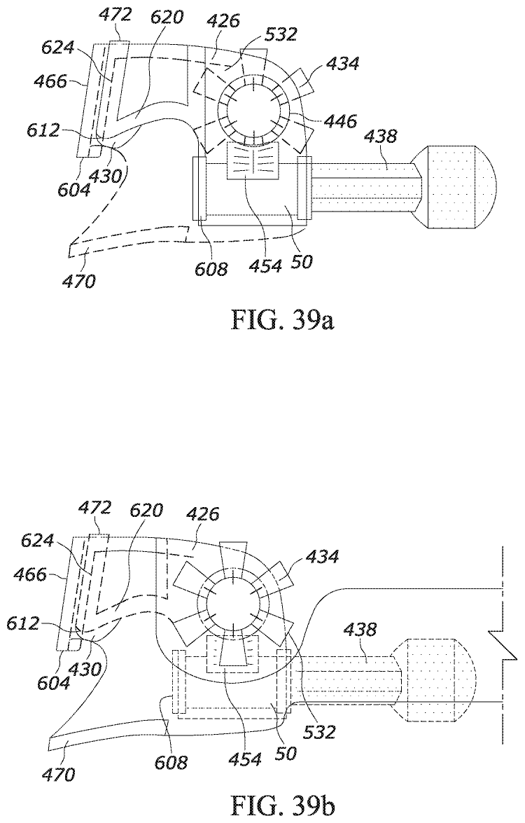

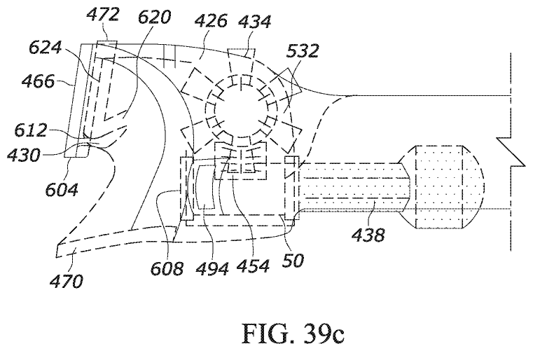

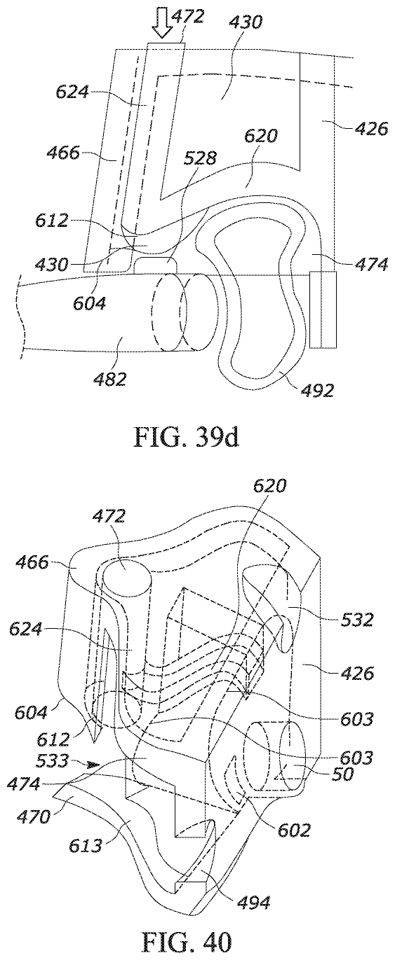

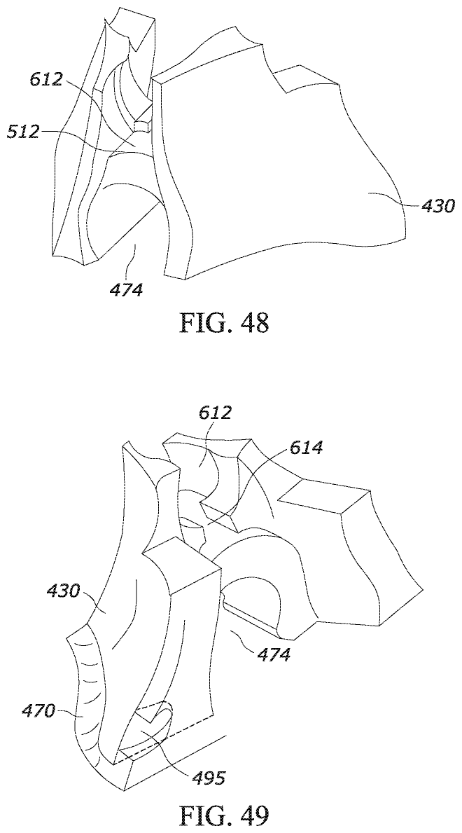

With reference to FIGS. 38a-38c (which show different cutaway side views of the tine body 426 viewed from the proximal side with the hex key 438 inserted), FIGS. 39a-39d (which show different cutaway front views of the tine body 426 with the hex key 438 inserted), FIG. 40 (which shows a front isometric view of a portion of the tine body 426 without the 430 pad or hex key 438), and FIGS. 48-49 (which show isometric views of the pad 430), the hex key 438 can be positioned in the cylinder 50, the tine body 426 includes entries 602 through which the extensions 490 of the leaf spring 488 can be inserted into the pathway 478 of the tine body 426 from the distal side and exits 494 through which the extensions 490 can extend out of the tine body 426 for connection to the matrix band 98, and the bevelled extensions 470 extend distally on opposite sides of the tine body 426. The body 426 includes a chamber or gap 474 defined on a proximal side in part by an arch wall shown by lines 603 in FIG. 40. The chamber 474 on the proximal side is further defined in part at the top by the cantilevered leaf spring 620. As shown in FIGS. 40 and 48-49, a distal side of the chamber 474 is defined by the pad 430, which is shaped and configured to be positioned above the bevelled extensions 470 and be flush with the bevelled surfaces of the extensions 470 and extend coronally within and to the top of the tine body 426 underneath a portion of the cantilevered leaf spring 620 to define an opening or tube 612 that extends upward from an apex 512 of the arch of the pad 430. The button 472/plunger 624 extends into and through the tube 612 defined by the pad 430. The pad 430 includes a passageway 614 through which the leaf spring 620 can extend.

Further, the pad 430 includes gaps 495 at proximal corners thereof that are configured to be aligned with the exits 494 of the tine body 426 when the pad 430 is positioned in, and connected to, the distal compartment 533 of the tine body 426. As discussed below, the extensions 490 of the leaf spring 488 extend out of the tine body 426 at the exits 494 and the gaps 495 of the pad 430. The gaps 495 may effectively define a distal wall of the exits 494 and provide more space or clearance for the extensions 490 to project toward the pad 430 and extend out of the tine body 426. During use, the elastic recoil of the matrix band 98 tends to pull the extensions 490 distally toward the pad 430, and the gaps 495 accommodate that distal displacement, thereby assisting in promoting a more uniform stress distribution along the extensions 490.

The chamber 474 (which may have a generally tube shape) allows the hex key 438 to extend out of the cylinder 50 from an exit 608 on the distal side. The bottom ends of the bevelled extensions 470 facing the tooth surface are exposed and not covered by the pad 430 so that they can engage teeth. When the hex key 438 exits the cylinder 50 in a distal direction into the chamber 474, the chamber 474 is configured to also receive and accommodate the ring spring 492 (or elastomer or wave spring or other flexible member).

As explained above, the chamber 474 is defined and secured in part by the arch wall of the tine body 426, which may be formed of a rigid elastomeric material, and which may be the same material as that used for the tine body 426 compartment or housing 532. This rigid structure maintains the integrity of the chamber 474 and resists inward forces transmitted through the pad 430 during placement of the ring separator 401 between teeth. The chamber 474 may be tubular in shape but may also be tubular with an open base, wherein the apical one-sixth of the tube is opened apically to relieve spring pressure and to avoid interference with buccolingual movement of the blade trailing edge 489. In that regard, the tip of the trailing edge 489 may extend beyond the apical boundary of the tine body 426 on the distal side. If so, distal/proximal translation of the hex key 438 may cause interference with the chamber 474 unless sufficient clearance is provided (or the chamber 474 is opened). Thus, the size of the opening in the chamber tube may depend on the blade 482 geometry (shape/size) and the available clearance. Additionally, the coronal one-sixth of the tube defined by the chamber 474 may also not be sealed, allowing for vertical movement of the cantilever leaf spring 620.

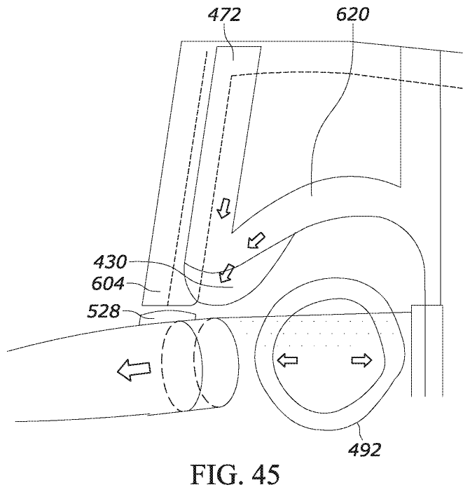

As shown in FIGS. 40, 48, and 49, above the bevelled extensions 470 and toward the exit 494, a stepped region 613 is formed to accommodate the thickness of the pad 430. The pad 430 provides the outer surface of a portion of the tube (on the distal side) defined by the chamber 474 and extends distally beyond the stepped region 613 to the notch 604. Immediately beneath the opening or tube 612 defined by the pad 430 that is proximal to the notch 604, the pad 430 extends to the opposite side of the tine body 426, forming an arch or tube that follows the contour of the open based tube defined by the arch wall of the tine body 426 on the proximal side. The pad 430 is shown to form an open-bottomed tube, but it may form a continuous arch or tube (i.e., it may not include openings or breaks like the proximal side defined by the arch wall). As explained above, above the apex 512 of the arch defined by the pad 430 is a plunger seating area. When the ring separator 401 is placed between teeth, the pad 430 engages the teeth such that the pad 430 is depressed or deformed inward. This inward displacement causes the pad 430 mass to intrude into the chamber 474 defined by the pad 430 at the distal end of the tine body 426, thereby disengaging the blade extension 528 from the notch 604. If disengagement does not occur through this mechanism alone, the button 472 may be actuated (pushed downward) causing the cantilever leaf spring 620 to move downward and push the pad 430 downward on the apex 512 to dislocate the blade extension 528 from the notch 604 (FIG. 39d and FIG. 45).

With reference to FIGS. 40, 48, and 49, the notch 604 extends from the extension 466 and beneath an opening 612. The button 472 (and the cantilevered leaf spring 620 and plunger 624 it is connected to) are positioned in a passage proximate the notch 604. The opening 612 receives the button 472 and plunger 624, and the cantilevered leaf spring 620 may be in the passageway 614 and extend into the opening 612. As discussed above, a portion of the pad 430, i.e., the apex 512, may extend directly under the opening 612 such that when the button 472 and plunger 624 are depressed, the pad 430 is pushed downward.

In operation, with respect to FIGS. 33a, 39d, and 41-43, the port 506 of the leaf spring 488 is aligned with the ports 496 of the ring spring 492, and the leaf spring extensions 490 of the leaf spring 488 are inserted through the entries 602 into the pathway 478 of the tine body 426 and out of the exits 494 of the tine body 426 (and the gaps 495 of the pad 430) such that the ring spring 492 and leaf spring 488 are positioned in the portion of the chamber 474 defined by the arch wall as an open tube chamber (on the more proximal side of the tine body 426) and the portion of the chamber defined by the pad 430 on the more distal side of the tine body 426 (which is positioned on the bevelled extensions 470), and the ring spring 492 is compressed in the chamber 474. The entries 602 may be slightly larger (such as via a taper) vertically than the exits 494 to accommodate twisting motion of the extensions 490 during hex key 438 rotation. The compartment 524 of the blade 482 is aligned with the port 506 of the leaf spring 488 opposite the ring spring 492. The blade 482 includes an external surface that may be made of a soft elastomer layer that interfaces an outer surface of a hard inner elastomer material that defines the compartment 524 that accommodates the tapered hex key 438.

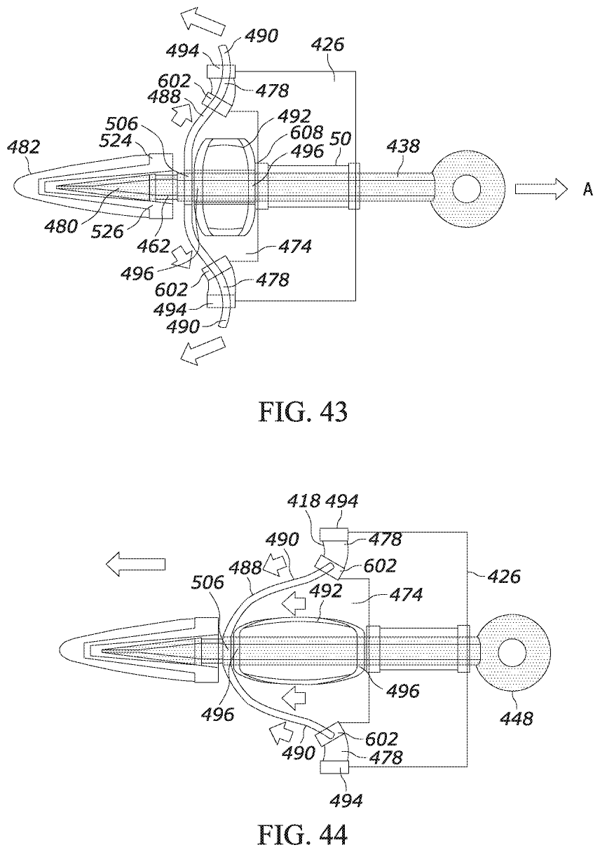

The tapered end 480 of the hex key 438 is inserted from the proximal side of the tine body 426 into the cylinder 50 and out the exit 608 of the cylinder 50 into the chamber 474. The tapered end 480 of the hex key 438 is further extended into the ports 496 of the ring spring 492 and through the port 506 of the leaf spring 488 and into the compartment 524 of the blade 482. The snap-in feature 462 of hex key 438 may snapably connect to the snap-in feature 526 of the compartment 524 of the blade 482 as described above. For simplicity, the triangular flap 439 of the hex key 438 is omitted in FIG. 43.

As this is being done, the hex key 438 can be pulled outwardly (out of the proximal side of the tine body 426 as shown by Arrow A in FIG. 43), which causes the extension 528 on top of the blade 482 to slide under and behind the notch 604 and under the opening 612 beneath the cantilevered leaf spring 620, with the apex 512 of the pad 430 positioned between the opening 612 and extension 528. In that state, the hex key 438, blade 482, ring spring 492, and leaf spring 488 are in a locked position with respect to the tine body 426 (as shown, for example, in FIGS. 39d and 43) and are held in the locked position by the extension 528 being retainably engaged with the notch 604. These steps of putting the blade 482, hex key 438, and springs 488 and 492 in the locked position can be done before inserting the ring separator 401 in a patient's mouth.

At this point, the sectional matrix band 98 can be connected to the leaf spring extensions 490 of the tine bodies 426 of ring separator 401 in a manner similar to that described above with respect to the embodiment shown in FIGS. 4-6a. In particular, with respect to FIGS. 27, 28, and 32, the leaf spring extensions 490 extending out of the exits 494 of the tine bodies 426 (and gaps 495 of the pad 430) are inserted into the slits 102 of the matrix band 98 to connect the matrix band 98 to the ring separator 401 and keep the matrix band 98 in position against the pads 430 of the tine bodies 426 prior to the matrix band 98 being positioned against the tooth that is to be restored. These steps can also be done before inserting the ring separator 401 into a patient's mouth.

After the matrix band 98 is secured to the leaf spring extensions 490, the ring separator 401 can be used to position the matrix band 98 on the tooth needing restoration. It should be noted the extensions 490 may also help stabilize the hex key 438 (or other shaped shaft embodiment) extending through the tine body 426. Also, the opening 102 of the matrix band 98 is a raised slit formed by lancing the matrix wall and displacing the material outwardly to define a flared, substantially half-conical guide surface to guide the extensions 490 into and out of the opening without interference. The user may use the pliers 58 (FIGS. 22a and 22b) to insert the ring separator 401 into the patient's mouth and position the matrix band 98, and, in particular, and as shown in FIG. 31, the user can operate the pliers 58 (by inserting the pliers 58 into the notches defined by the arms 418) to extend the legs 414, and thus the tine bodies 426, away from each other and temporarily deform/flatten the matrix band 98 for positioning between teeth and against the tooth needing restoration.

Once the matrix band 98 is positioned in place, the user can disengage the pliers 58 from the ring separator 401, which allows restorative forces of the body 410 to spring the legs 414 back toward each other and to their original positions (as shown in FIGS. 27 and 28). With reference to FIGS. 39d, 44 and 45, as the legs 414 move back toward each other, the recoil force of the ring body 410 compresses the pads 430 of the tine bodies 426 against the teeth surfaces, displacing the pads 430 proximally and apically within the tine bodies 426. The chamber 474 on the distal side of each tine body 426 (which is defined by the pad 430) may be sealed, except for the small opening 612 proximal to the notch 604. The compression and displacement of each pad 430 causes the apex portion 512 of the pad 430 above the extension 528 to push the extension 528 downward apically such that the extension 528 moves under and distally away from the notch 604. With respect to FIGS. 44 and 45, this allows the ring spring 492 and/or the leaf spring 488 to expand, which causes the hex key 438 to move distally within the cylinder 50 of the tine body 426, which in turn (i) drives the blades 482 of the two tine bodies 426 toward each other into the proximal space between the teeth and behind the matrix band 98 (which is engaged with the tooth needing restoration) and such that engagement of the rotating blade 482 with the matrix 98 and the tooth surface creates a lever effect that may increase the interproximal space between the teeth, and (ii) causes the blade extensions 490 to be pulled into the tine bodies 426 away from, and to be withdrawn from, the slits 102 of the matrix band 98. In that state, as shown in FIG. 44, the hex key 438, blade 482, ring spring 492, and leaf spring 488 are in an unlocked position with respect to the tine body 426. The ring spring 492 can provide the primary recoil force during firing, but the leaf spring 488 can contribute to that recoil force as well. The ball 448 on the hex key 438 prevents the hex key 438 from going past a certain point distally into the tine body 426 during the unlocking step.

Thus, seating the ring separator 401 on the teeth can automatically drive the extension 528 downward, unlocking the blade 482 and hex key 438, and the recoil forces from the ring spring 492 and leaf spring 488 push them distally out of the gap 474. When the matrix band 98 is positioned on the proximal surface of the teeth between the prepared tooth surface/root and the interproximal gingiva, the gingival-facing outer surface of the matrix band 98 guides the blades 482 to slide along the matrix band 98 surface toward each other.

With respect to FIG. 45, if the compressed and displaced pad 430 fails to push the extension 528 fully down and past the notch 604 and out of the chamber 474 upon the recoiling of the ring separator 401, the button 472 can be pressed with a tool or finger, which causes the cantilevered leaf spring 620 and plunger 624 to move downward and push the pad 430 downward, which in turn pushes the extension 528 down and past the notch 604.

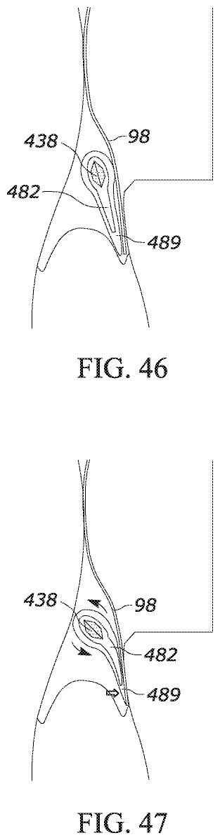

Once the hex keys 438 and blades 482 of the two tine bodies 426 have moved toward each other between the teeth to create space for the matrix band 98 and apply pressure against the matrix band 98 to seal it about the tooth needing restoration, the gear system in each tine body 426 can be used to generate torque and rotate the blades 482 to further seal the matrix band 98 along the gingival line of the tooth. In that regard, the user can rotate the gear knobs 434 (shown at FIG. 37a), which, as discussed above, in turn, via the worm gear system, causes the hex keys 438 to rotate. With respect to FIGS. 46 and 47, as a hex key 438 rotates, for example, in the counter clockwise direction, it causes the blade 482 (including the trailing edge 489) in which it is inserted, and locked to, to rotate up against the matrix band 98 along the gingival line and thus create a tighter cervical seal of the band 98 against the tooth surface. With respect to FIG. 46, the blade 482 for each tine body 426 may initially be angled toward the matrix band 98 to secure its position relative to the matrix band 98 before rotation of the hex key 438.

With the extensions 490 from the leaf spring 488 passing through the tine bodies 426, four points of contact on the sectional matrix band 98 are provided. In that regard, the matrix band 98 is secured through its slits 102 by two leaf spring extensions 490 from the respective tine bodies 426, thereby creating two points of contact against the band 98. Then the gear knob 434 is rotated slightly toward the matrix band 98. This rotation causes the trailing edges 489 of each blade 482 to support the gingival portion of the matrix band 98 near the color-marked band 92, thereby providing two additional points of contact (from each blade 482) against the matrix band 98. This configuration also produces a tighter seal between the gingival edge of the matrix band 92 and the trailing edge 489 of the blade 482, forming a single knife-like interface that allows the blade 482 to more easily slide through the gingival sulcus between the gingiva and the matrix band 98 during the unlocking mechanism.

Alternatively, or additionally, and with reference to FIGS. 44 and 46-47, during operation a user may insert a tool into the hole 452 in the ball 448 of the hex key 438 to rotate the hex key 438. The hole 452 can also be used as a visual indicator of the orientation of the hex key 438, and thus the blade 482, and the degree of rotation of the blade 482 relative to the tine body 426, both before and after placement of the ring separator 401 in the patient's mouth. The hole 452 can receive an instrument (such as a dental explorer or probe) so that the position of the hex key 438 can be changed with respect to the tine body 426.

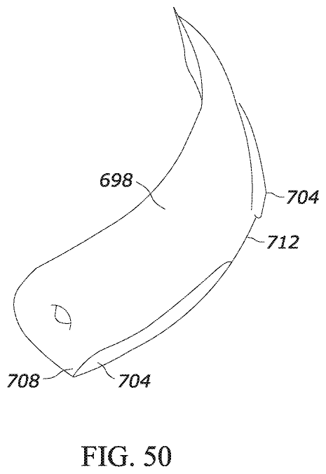

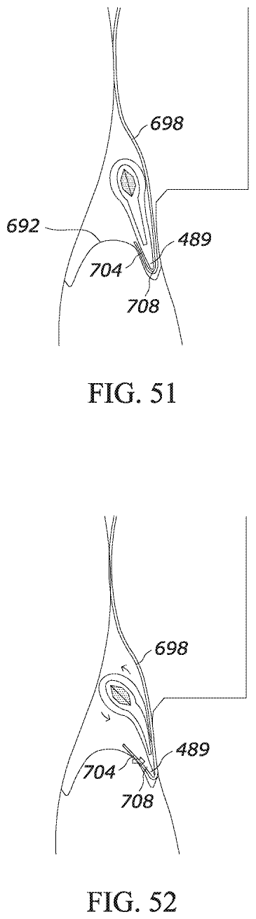

With reference to FIGS. 50-52, an alternative version of the matrix band 698 may be used with the embodiments described herein. The band 698 may include a folded bottom portion or portions 704. Each folded portion 704 may define a channel 708 along the gingival margin 692 on the side of the band 698 to be positioned opposite the prepared tooth surface. The channels 708 may be V-shaped or U-shaped, for example. The channels 708 are configured to receive the tip of the trailing edge 489 of a blade 482 and guide the blades 482 as they advance toward each other in buccolingual direction between the teeth. The channels 708 may help reduce soft-tissue resistance to that movement of the blades 482 and reduce the likelihood that a blade 482 will contact or traumatize the gingival region.

The band 698 may include a gap or relief area 712 located generally mid-band between the channels 708 or where the channels 708 terminate. The relief area 712 may serve as a stress/tension relief zone when the band 698 is deformed by a separator ring, thereby distributing strain, reducing localized deformation, and limiting distortion of the band 698 The relief area 712 may also facilitate the placement and seating (in the coronal-apical direction) of the band 698 within the tight interproximal space near the teeth contact.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A dental implement for use in engaging a matrix band, comprising:
at least one body with a distal side configured to be positioned against two adjacent teeth;
a flexible blade extending from the distal side of the body, wherein when the body is positioned against the two teeth, the blade is positioned between the teeth and is configured to be rotated such that the blade engages the matrix band to push the matrix band against one of the teeth.

2. The dental implement of claim 1, wherein the body includes a gear that is configured to rotate the blade.

3. The dental implement of claim 2, wherein the body receives a shaft on a proximal side thereof and the shaft engages the gear and blade such that the gear causes the blade to rotate by rotating the shaft.

4. The dental implement of claim 1, wherein, the blade is configured to push the teeth apart to increase interproximal space therebetween.

5. The dental implement of claim 3, further comprising a flexible member and a spring, wherein the spring includes at least one extension that extends through a pathway in the body and is configured to be connected to the matrix band.

6. The dental implement of claim 5, wherein the shaft extends out a distal side of the body and through the flexible member and the spring and is configured to be lockingly engaged to the blade.

7. The dental implement of claim 6, wherein the body engages the blade to retain the flexible member and the spring in a chamber in the body with the flexible member in a contracted state.

8. The dental implement of claim of claim 7, further including a pad positioned in the body, and at least one of the pad and body define the chamber.

9. The dental implement of claim 8, further comprising an open ring with two flexible legs and two bodies, wherein each leg includes a body connected at an end thereof.

10. The dental implement of claim 9, wherein when the ring is positioned in a patient's mouth to position the matrix band between the teeth, the legs are released from an expanded position to a contracted position, the contraction causing the pad on each body to deform and disengage the blade from the body such that the flexible member expands and causes the shaft to move axially out of the distal side of the body and between the two teeth and causes the extension to disengage from the matrix band and retract into the body.

11. The dental implement of claim 7, wherein the blade includes an extension that retainably engages a notch of the tine body.

12. The dental implement of claim 5 wherein the flexible member is a ring spring, wave spring, coil spring, or prolate shaped elastomer, and the spring is a leaf spring.

13. The dental implement of claim 3, wherein the shaft is a hex key.

14. The dental implement of claim 2, wherein the gear includes a knob connected by gears to a cylinder in the body that receives the shaft such that rotation of the knob causes the shaft to rotate.

15. The dental implement of claim 3, wherein the shaft includes a stop at one end to prevent the shaft from moving into the body beyond a certain point.

16. The dental implement of claim 7, wherein the body includes a button that is configured to be depressed to cause the blade to disengage from the body such that the flexible member expands and causes the shaft to move axially out of the body and between the two teeth and causes the extension to disengage from the matrix band.

17. A dental implement for inserting a matrix band, comprising:
an open ring with flexible legs;
a body positioned on at least one of the legs and that is configured to releasably engage the matrix band;
a shaft configured to be received within the body;
a flexible blade that is configured to be connected to the shaft; and
a gear configured to rotate the shaft;
wherein, when the implement is inserted in a patient's mouth to position the matrix band along a first tooth, the shaft and blade are configured to move axially between the first tooth and a second tooth adjacent the first tooth and be rotated by the gear system to apply pressure on the matrix band to press the matrix band against a portion of the first tooth.

18. The dental implement of claim 17, further comprising a flexible member and a spring with at least one extension configured to be connected to the matrix band, wherein the shaft extends through the flexible member and the spring and is configured to be lockingly engaged to the blade, and wherein the body retainably engages the blade to retain the flexible member and the spring in a contracted state.

19. The dental implement of claim of claim 18, further comprising a pad positioned on the body, wherein when the ring separator is positioned in the patient's mouth to position the matrix band between teeth, the legs are released from an expanded position to a contracted position, the contraction causing the pad to deform and disengage the blade from the tine body, which allows the flexible member to expand and (i) drive the shaft axially out of the body and between the first tooth and a second tooth and (ii) pull the extension such that it disengages from the matrix band.

20. The dental implement of claim 18, wherein the body includes a button that is configured to be depressed to cause the blade to disengage from the tine body.
